(19) United States
(12) Patent Application Publication
(10) Pub. No.: US 2026/0070741 A1
(43) Pub. Date: Mar. 12, 2026

(54) BEARING CHAIN ASSEMBLY

(71) Applicant: John Bean Technologies AB, Helsingborg (SE)

(72) Inventors: Anton Persson, Lund (SE); Göran Gramby, Bjärred (SE); Bo Richard Jimmy Carlsson, Potenza Picena (IT)

(73) Assignee: John Bean Technologies AB, Helsingborg (SE)

(21) Appl. No.: 19/323,664

(22) Filed: Sep. 9, 2025

Related U.S. Application Data
(60) Provisional application No. 63/692,950, filed on Sep. 10, 2024.

(51) Int. Cl. B65G 33/32

(52) U.S. Cl. CPC B65G 33/32

(57) ABSTRACT

A bearing chain assembly may include vertical load bearings each having a first rotation axis and configured to roll along horizontal support structure of a drive system while supporting vertical loads of a spiral conveyor belt; radial load bearings alternately coupled with the vertical load bearings and each including: a roller assembly configured to facilitate rolling of the bearing chain assembly along vertical support structure of the drive system while supporting radial loads of the spiral conveyor belt and/or the drive system. The roller assembly includes first and second roller wheels each having a rotation axis substantially perpendicular to the first rotation axis and made of a first material; a first glide bearing secured to the first roller wheel, the first glide bearing made of a second material having a lower frictional resistance than the first material; and a connection assembly for coupling the first wheel to the second wheel.

### CROSS-REFERENCE TO RELATED APPLICATION

This application claims the benefit of U.S. Provisional Application No. 63/692950, filed Sep. 10, 2024, the entire contents of which are incorporated herein by reference.

### BACKGROUND

Spiral conveyor-based thermal processing systems include a cooking surface or a cooling/freezing surface in the form of a pervious conveyor belt for conveying workpieces, including food, through a thermal processing chamber in a spiral or helical path. If the workpiece is being cooled or frozen, a source of cooling medium is provided either within the cooling/freezing chamber or adjacent thereto.

An advantage of thermal processing systems utilizing spiral conveyor belts is that a relatively long processing path can be achieved with a small footprint. For example, a 600-foot-long thermal processing conveyor belt in a spiral configuration can be contained within a 20-foot×20-foot×20-foot housing. However, spiral conveyor-based thermal processing systems require a robust drive system to support and move the stacked, spiral conveyor through the thermal processing path.

Components of the drive system for the stacked, spiral conveyor are subject to cyclic loading and fatigue stress, which can result in crack propagation and wear on the components within the drive system. Systems and methods disclosed herein relate to improved drive systems for spiral conveyor-based thermal processing systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some aspects, the techniques described herein relate to a bearing chain assembly for use in a spiral conveyor belt drive system, including: a plurality of vertical load bearings configured to roll along horizontal support structure of the drive system while supporting vertical loads of a spiral conveyor belt, each of the plurality of vertical load bearings having a first rotation axis; and a plurality of radial load bearings alternately coupled with the plurality of vertical load bearings, each radial load bearing including: a roller assembly configured to facilitate rolling of the bearing chain assembly along vertical support structure of the drive system while supporting radial loads of at least one of the spiral conveyor belt and the drive system, the roller assembly including a first roller wheel having a first rolling surface and positioned opposite and substantially mirrored in configuration relative to a second roller wheel having a second rolling surface, the first and second roller wheels having a rotation axis substantially perpendicular to the first rotation axis, the first and second roller wheels made of a first material; a glide bearing assembly configured to facilitate sliding movement of the bearing chain assembly along curved support structure of the drive system, the glide bearing assembly including a first glide bearing secured to the first roller wheel and a second glide bearing secured to the second roller wheel, the first and second glide bearings made of a second material having a lower frictional resistance than the first material; and a connection assembly configured to couple the first wheel to the second wheel.

In some aspects, the techniques described herein relate to a radial load bearing for use in a bearing chain assembly having a plurality of radial load bearings alternately coupled with a plurality of vertical load bearings configured to roll along horizontal support structure of a drive system while supporting vertical loads of a spiral conveyor belt, each of the plurality of vertical load bearings having a first rotation axis, each radial load bearing including: a roller assembly configured to facilitate rolling of the bearing chain assembly along vertical support structure of the drive system while supporting radial loads of at least one of the spiral conveyor belt and the drive system, the roller assembly including a first roller wheel having a first rolling surface positioned opposite and substantially mirrored in configuration relative to a second roller wheel having a second rolling surface, the first and second roller wheels having a rotation axis substantially perpendicular to the first rotation axis, the first and second roller wheels made of a first material; a glide bearing assembly configured to facilitate sliding movement of the bearing chain assembly along curved support structure of the drive system, the glide bearing assembly including a first glide bearing secured to the first roller wheel and a second glide bearing secured to the second roller wheel, the first and second glide bearings made of a second material having a lower frictional resistance than the first material; and a connection assembly configured to couple the first wheel to the second wheel.

In some aspects, the techniques described herein relate to a spiral conveyor belt assembly for a thermal processing system, including: a perforated conveyor belt; a supporting structure configured to hold the conveyor belt in a series of spiral tiers; a drive system configured to drive a drive chain for moving the conveyor belt; and a bearing chain assembly configured for supporting movement of the drive chain and conveyor belt, including: a plurality of vertical load bearings configured to roll along horizontal support structure of the drive system while supporting vertical loads of a spiral conveyor belt, each of the plurality of vertical load bearings having a first rotation axis; a plurality of radial load bearings alternately coupled with the plurality of vertical load bearings, each radial load bearing including: a roller assembly configured to facilitate rolling of the bearing chain assembly along vertical support structure of the drive system while supporting radial loads of at least one of the spiral conveyor belt and the drive system, the roller assembly including a first roller wheel having a first rolling surface and positioned opposite and substantially mirrored in configuration relative to a second roller wheel having a second rolling surface, the first and second roller wheels having a rotation axis substantially perpendicular to the first rotation axis, the first and second roller wheels made of a first material; a glide bearing assembly configured to facilitate sliding movement of the bearing chain assembly along curved support structure of the drive system, the glide bearing assembly including a first glide bearing secured to the first roller wheel and a second glide bearing secured to the second roller wheel, the first and second glide bearings made of a second material having a lower frictional resistance than the first material; and a connection assembly configured to couple the first wheel to the second wheel.

In some aspects, the techniques described herein relate to a bearing chain assembly for use in a spiral conveyor belt drive system, including: a plurality of vertical load bearings configured to roll along horizontal support structure of the drive system while supporting vertical loads of a spiral conveyor belt, each of the plurality of vertical load bearings having a first rotation axis; and a plurality of radial load bearings alternately coupled with the plurality of vertical load bearings, each radial load bearing including: a roller assembly configured to facilitate rolling of the bearing chain assembly along vertical support structure of the drive system while supporting radial loads of at least one of the spiral conveyor belt and the drive system, the roller assembly including a first roller wheel having a first rolling surface and positioned opposite and substantially mirrored in configuration relative to a second roller wheel having a second rolling surface, the first and second roller wheels having a rotation axis substantially perpendicular to the first rotation axis, the first and second roller wheels made of a first material; a glide bearing assembly configured to facilitate sliding movement of the bearing chain assembly along curved support structure of the drive system, the glide bearing assembly including a first glide bearing secured to the first roller wheel, the first glide bearing made of a second material having a lower frictional resistance than the first material; and a connection assembly configured to couple the first wheel to the second wheel.

In some aspects, the techniques described herein relate to a radial load bearing for use in a bearing chain assembly having a plurality of radial load bearings alternately coupled with a plurality of vertical load bearings configured to roll along horizontal support structure of a drive system while supporting vertical loads of a spiral conveyor belt, each of the plurality of vertical load bearings having a first rotation axis, each radial load bearing including: a roller assembly configured to facilitate rolling of the bearing chain assembly along vertical support structure of the drive system while supporting radial loads of at least one of the spiral conveyor belt and the drive system, the roller assembly including a first roller wheel having a first rolling surface positioned opposite and substantially mirrored in configuration relative to a second roller wheel having a second rolling surface, the first and second roller wheels having a rotation axis substantially perpendicular to the first rotation axis, the first and second roller wheels made of a first material; a glide bearing assembly configured to facilitate sliding movement of the bearing chain assembly along curved support structure of the drive system, the glide bearing assembly including a first glide bearing secured to the first roller wheel, the first glide bearing made of a second material having a lower frictional resistance than the first material; and a connection assembly configured to couple the first wheel to the second wheel.

In some aspects, the techniques described herein relate to a spiral conveyor belt assembly for a thermal processing system, including: a perforated conveyor belt; a supporting structure configured to hold the conveyor belt in a series of spiral tiers; a drive system configured to drive a drive chain for moving the conveyor belt; and a bearing chain assembly configured for supporting movement of the drive chain and conveyor belt, including: a plurality of vertical load bearings configured to roll along horizontal support structure of the drive system while supporting vertical loads of a spiral conveyor belt, each of the plurality of vertical load bearings having a first rotation axis; a plurality of radial load bearings alternately coupled with the plurality of vertical load bearings, each radial load bearing including: a roller assembly configured to facilitate rolling of the bearing chain assembly along vertical support structure of the drive system while supporting radial loads of at least one of the spiral conveyor belt and the drive system, the roller assembly including a first roller wheel having a first rolling surface and positioned opposite and substantially mirrored in configuration relative to a second roller wheel having a second rolling surface, the first and second roller wheels having a rotation axis substantially perpendicular to the first rotation axis, the first and second roller wheels made of a first material; a glide bearing assembly configured to facilitate sliding movement of the bearing chain assembly along curved support structure of the drive system, the glide bearing assembly including a first glide bearing secured to the first roller wheel, the first glide bearing made of a second material having a lower frictional resistance than the first material; and a connection assembly configured to couple the first wheel to the second wheel.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

The novel features of the invention are set forth with particularity in the appended claims. A better understanding of the features and advantages of the present invention will be obtained by reference to the following detailed description that sets forth illustrative examples, in which the principles of the invention are utilized, and the accompanying drawings of which:

FIG. 1 shows a perspective view of an exemplary spiral self-stacking conveyor belt system including a self-stacking conveyor belt and a drive assembly for driving the conveyor belt in accordance with examples of the present disclosure.

FIG. 2 is a top view of exemplary inner and outer drive chain assemblies of the drive assembly for the spiral self-stacking conveyor belt system of FIG. 1.

FIG. 3 shows a cross-sectional front view showing an example of the inner and outer drive chain assemblies of FIG. 2 within inner and outer drive channels of the drive assembly, wherein each of the inner and outer drive chain assemblies includes a drive chain portion and a bearing chain portion.

FIG. 4 shows a perspective view of an exemplary bearing chain assembly for use as the bearing chain portion of the drive chain assembly of FIG. 3, wherein the bearing chain assembly includes alternately coupled vertical load bearings and radial load bearings, wherein the bearing chain assembly is shown in a curved drive channel of a drive assembly.

FIG. 5 shows a perspective view of the bearing chain assembly of FIG. 4.

FIG. 6 shows an exploded perspective view of the bearing chain assembly of FIG. 4.

FIG. 7 shows a side cross-sectional view of a portion of the bearing chain assembly of FIG. 4.

FIG. 8 shows a perspective cross-sectional view of a radial load bearing of the bearing chain assembly of FIG. 4.

FIG. 9 shows a top view of a radial load bearing of the bearing chain assembly of FIG. 4.

FIG. 10 shows a perspective view of a biasing device of a radial load bearing of the bearing chain assembly of FIG. 4.

FIG. 11 shows a side cross-sectional view of the bearing chain assembly of FIG. 4 moving along a curved drive channel of a drive assembly.

FIG. 12 shows a perspective view of an alternative exemplary bearing chain assembly for use as the bearing chain portion of a drive chain assembly, wherein the bearing chain assembly includes alternately coupled vertical load bearings and radial load bearings.

FIG. 13 shows a perspective cross-sectional view of a radial load bearing of the bearing chain assembly of FIG. 12.

FIG. 14 shows a top view of a biasing device of a radial load bearing of the bearing chain assembly of FIG. 13.

FIG. 15 shows a perspective view of another alternative exemplary bearing chain assembly for use as the bearing chain portion of a drive chain assembly, wherein the bearing chain assembly includes alternately coupled vertical load bearings and radial load bearings.

FIG. 16 shows an exploded perspective view of the bearing chain assembly of FIG. 15.

FIG. 17 shows a side cross-sectional view of a portion of the bearing chain assembly of FIG. 15.

FIG. 18A shows a perspective cross-sectional view of a radial load bearing of the bearing chain assembly of FIG. 19A.

FIG. 18B shows a perspective cross-sectional view of a radial load bearing of the bearing chain assembly of FIG. 19B.

FIG. 19A shows a top view of a radial load bearing of the bearing chain assembly of FIG. 15.

FIG. 19B shows a top view of a radial load bearing of the bearing chain assembly of FIG. 15.

FIG. 20 shows a perspective view of another alternative exemplary bearing chain assembly for use as the bearing chain portion of a drive chain assembly, wherein the bearing chain assembly includes alternately coupled vertical load bearings and radial load bearings.

FIG. 21 shows an exploded perspective view of the bearing chain assembly of FIG. 20.

FIG. 22 shows a side cross-sectional view of a portion of the bearing chain assembly of FIG. 20.

FIG. 23A shows a perspective cross-sectional view of a radial load bearing of the bearing chain assembly of FIG. 24A.

FIG. 23B shows a perspective cross-sectional view of a radial load bearing of the bearing chain assembly of FIG. 24B.

FIG. 24A shows a top view of a radial load bearing of the bearing chain assembly of FIG. 20.

FIG. 24B shows a top view of a radial load bearing of the bearing chain assembly of FIG. 20.

### DETAILED DESCRIPTION

Systems and methods disclosed herein are directed to improved components of a drive assembly for spiral conveyor-based thermal processing systems. A spiral conveyor-based drive system typically uses bearing assemblies to support and enable circular movement of the stack. In some systems, the bearing assembly is configured as a roller drive chain assembly. Roller components of roller drive chain assemblies typically need to be able to carry the vertical load from the stack. At the same time, the roller components typically need to be able to withstand horizontal forces from the wrapping of the drive chain assemblies and the wrapping and tension imposed by the conveyor belt. Roller components are therefore subject to cyclic loading and fatigue stress, which can result in crack propagation and wear of the components. Cracks and component wear can lead to untimely repairs, slowing down production. Ensuring maximum longevity of a bearing chain assembly within a conveyor drive system thus helps optimize efficiency and limits expenses for a spiral conveyor-based thermal processing system.

Systems and methods disclosed herein relate to improved bearing chain assemblies for use in a drive assembly of a spiral conveyor belt system. The bearing chain assemblies described herein include roller components that are configured to maximize wear resistance and decrease cyclic loading, which prolongs the lifespan of the assembly, increases efficiency, and decreases time and money spent on repairs.

Although the systems and methods disclosed herein are described with reference to a drive assembly of a spiral conveyor belt system, and specifically, a spiral conveyor belt system of a freezer, it should be appreciated that the bearing chain assembly or any of its roller components may instead be used in any other suitable drive assembly or similar. Thus, the descriptions and illustrations provided herein should not be seen as limiting.

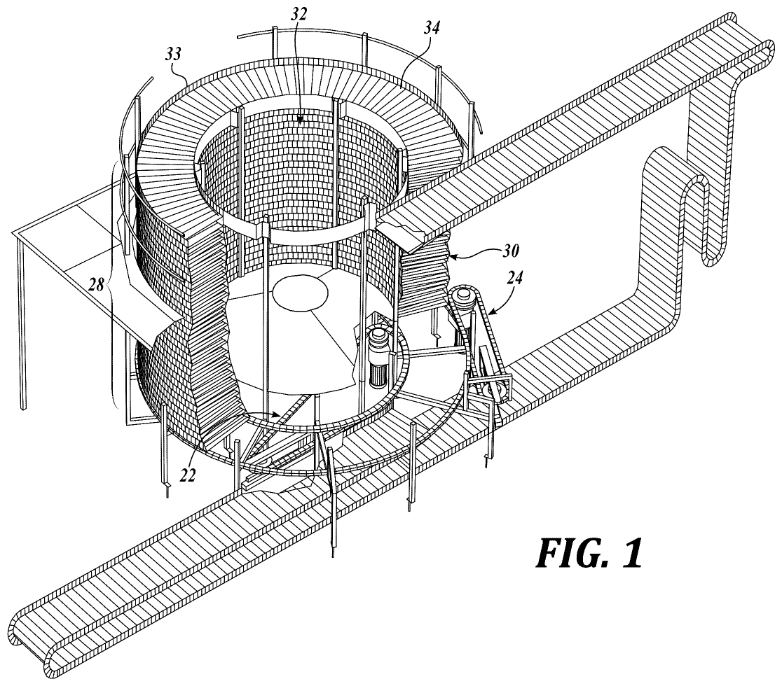

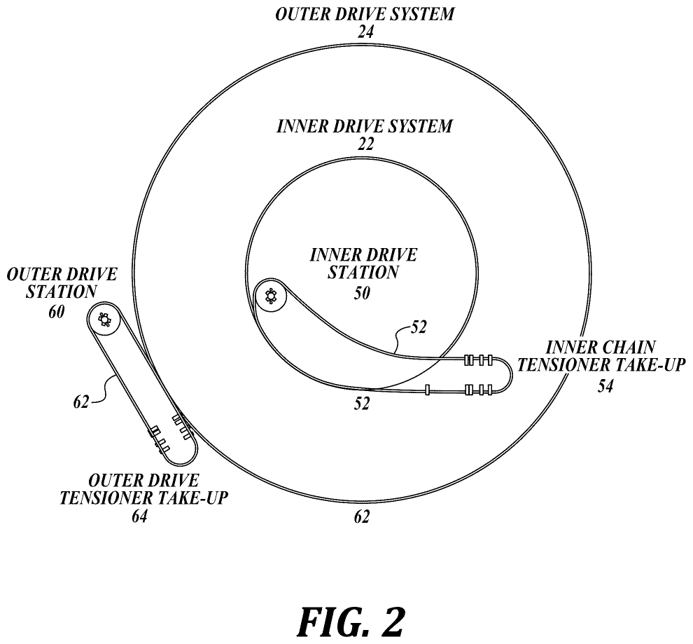

An overview of an exemplary spiral conveyor-based thermal processing system and its drive assembly will first be provided with reference to FIGS. 1 and 2.

In spiral conveyor belt assemblies, food products are arranged on a conveyor belt and exposed to an airflow. The airflow can be arranged, for instance, to freeze or heat the product. As may be appreciated with reference to FIG. 2, the sequence of operations typically consists of the food product being placed on a linear inlet portion of a conveyor belt 34, moved into a spiral stack 28, and heated or frozen by treated air while being conveyed in the spiral path of the conveyor belt 34 in the spiral stack 28. Once the food exits the spiral stack 28, it is removed from a linear outlet portion of the conveyor belt 34.

When formed as a spiral stack 28, the conveyor belt 34 is coiled in a generally spiral configuration to form a plurality of spiral tiers 30 stacked one above the other so that sidewall portions of each tier form a substantially continuous inner cylindrical wall-like surface 32 and outer cylindrical wall-like surface 33. Air flow through the stack 28 can be freely circulated between the spaced edges of adjacent tiers 30, vertically through the perforated conveyor belt 34, and/or through the compartment defined by the inner cylindrical wall-like surface 32. The spiral stack 28 may have any number of tiers 30, and in the case of industrial freezer, typically in the range of about 30 to about 45 tiers.

Other suitable examples of spiral self-stacking conveyor belts are shown and described in U.S. Pat. No. 3,938,651, entitled “Self-supporting spiral conveyor”, U.S. Pat. No. 5,803,232, entitled “Conveyor belt”, and U.S. Pat. App. Pub. No. US20080302638A1, entitled “Supporting Installation”, the disclosures of which are hereby expressly incorporated by reference. However, other suitable spiral belt assemblies are also within the scope of the present disclosure.

The conveyor belt 34 is driven by a drive assembly 26. In the example shown, the drive assembly 26 includes inner and outer drive systems 22 and 24 for driving at least the spiral stack 28.

Referring to FIG. 2, the inner drive system 22 may include an inner drive station 50, an inner bearing chain assembly 52, and an inner chain tensioner 54. The outer drive system 24 may include an outer drive station 60, an outer bearing chain assembly 62, and an outer chain tensioner 64. The inner and outer roller drive chain assemblies 52 and 62 each include a drive chain generally defined by a plurality of links arranged in a continuous loop. The inner and outer drive stations 50 and 60 engage the links in the respective roller drive chain assemblies 52 and 62 for driving inner and outer portions of the conveyor belt 34.

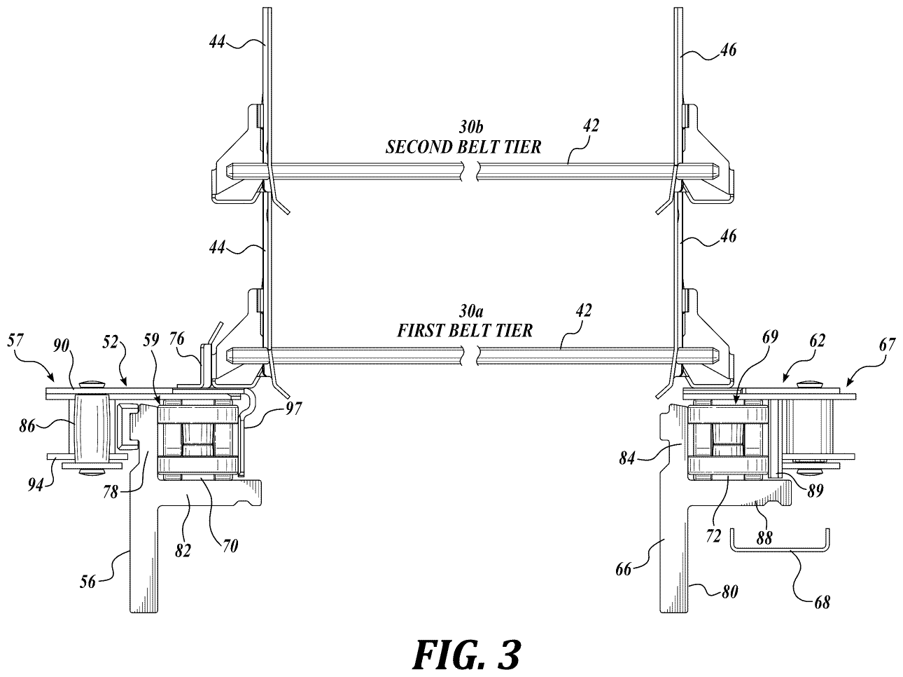

FIG. 3 shows a cross-sectional end view of the spiral self-stacking conveyor belt system of FIG. 1, with portions of the inner and outer drive systems 22 and 24 supporting inner and outer portions of the stack 28 defined by the conveyor belt 34. In the example shown, the conveyor belt 34, shown in part as two tiers 30a and 30b of the spiral stack 28, includes inner links 44 and outer links 46 spaced apart by transverse rods 42 (which are interconnected by intermediate links, not shown). The inner and outer links 44 and 46 are configured to enable spiral self-stacking of the conveyor belt 34 to define the belt tiers 30. When arranged in the stack 28, the inner links 44 and outer links 46 of the conveyor belt 34 define the inner and outer cylindrical wall-like surfaces 32 and 33, respectively.

The inner and outer links 44 and 46 also enable interaction of the belt 34 with the inner and outer drive systems 22 and 24 for driving the stack 28. Specifically, the inner links 44 of the conveyor belt 34 are driven by the inner bearing chain assembly 52 of the inner drive system 22, and the outer links 46 of the conveyor belt 34 are driven by the outer bearing chain assembly 62 of the outer drive system 24. The inner and outer drive systems 22 and 24 drive the inner and outer roller drive chain assemblies 52 and 62 at appropriate speeds to drive the conveyor belt 34 along the helical path of the spiral stack 28.

The inner and outer roller drive chain assemblies 52 and 62 each include a drive chain portion and a bearing chain portion. Specifically, the inner bearing chain assembly 52 includes an inner drive chain portion 57 and an inner bearing chain portion 59, and the outer bearing chain assembly 62 includes an outer drive chain portion 67 and an outer bearing chain portion 69.

The drive chain portions 57/67 and bearing chain portions 59/69 of the inner and outer roller drive chain assemblies 52 and 62 are supported by and movable along suitable supporting structure. In the example shown, the inner bearing chain assembly 52 is supported by and movable along an inner support rail 56, and the outer bearing chain assembly 62 is supported by and movable along an outer support rail 66.

Exemplary aspects of the inner drive chain portion 57 of the inner bearing chain assembly 52, and how it is supported by and interacts with the corresponding inner support rail 56, will now be described. In general, the inner drive chain portion 57 of the inner bearing chain assembly 52 may be generally configured like the inner drive chain portion shown and described in U.S. Pat. No. 10,889,448, entitled “Systems and methods for chain wear elongation measurement and drive compensation”, the entire disclosure of which is incorporated by reference herein. Accordingly, the inner drive chain portion 57 and corresponding inner support rail 56 will only be briefly described.

In the depicted example, the inner drive chain portion 57 is made up of a plurality of links defined by first and second or upper and lower horizontally planar pitches 90 and 94 moveably coupled to one another via transverse coupling pin assemblies (pin/bushing assembly 86 shown in FIG. 3).

The upper horizontally planar pitch 90, which has a length greater than the lower pitch 94 and extends radially inwardly toward the spiral stack 28, includes upwardly extending flanges 76 for interacting with the first tier 30a of the conveyor belt 34. The upper pitch 90 further includes downwardly extending flanges 97 configured to define, in part, an inner bearing chain portion channel 70. The outer drive chain portion 67 is substantially similar to the inner drive chain portion 57 in that it includes upper and lower horizontally planar pitches coupled to one another via transverse coupling pins, and upwardly extending flanges for interacting with the first tier 30a of the conveyor belt 34.

The inner bearing chain assembly 52 interacts with the inner support rail 56 to facilitate movement of the inner bearing chain assembly 52 about an inner drive and return path of the inner drive system 22. As noted above, the upper pitch 90 includes downwardly extending vertical flanges 97 configured to define, in part, an inner bearing chain portion channel 70. Specifically, the vertical flanges 97 define a radially inner vertical wall of the bearing chain portion channel 70. Portions of the inner support rail 56 define a lower horizontal wall 82 and a radially outer vertical wall 78 of the inner bearing chain portion channel 70. The inner bearing chain portion channel 70 is sized and configured to house the inner bearing chain portion 59 of the inner bearing chain assembly 52.

The inner drive chain portion 57 is located outside the radially outer vertical wall 78 of the inner bearing chain portion channel 70 and is configured to move along an outer surface of the radially outer vertical wall 78 (such as through a keyed interface) when driven by the inner drive station 50. The inner bearing chain portion 59 moves within the inner bearing chain portion channel 70 to support the horizontal movement of the inner drive chain portion 57 and to support movement of the spiral stack 28.

The outer bearing chain assembly 62 similarly interacts with the outer support rail 66 to facilitate movement of the outer bearing chain assembly 62 about the outer drive and return path of the outer drive system 24. The radial forces acting on the inner and outer roller drive chain assemblies 52 and 62 differ slightly; and therefore, the structure supporting the inner bearing chain assembly 52 differs slightly from the structure supporting the outer bearing chain assembly 62. For instance, an outer bearing chain portion channel 72 is defined by the upper horizontally planar pitch 90 of the outer drive chain portion 67 and the outer support rail 66. Portions of the outer support rail 66 define a lower horizontal wall 88 and radially inner vertical wall 84. A vertical wall portion 89 extends downwardly from the upper horizontally planar pitch 90 to define an outer wall of the outer bearing chain portion channel 72. The outer bearing chain portion channel 72 is sized and configured to house the outer bearing chain portion 69 of the outer bearing chain assembly 62.

The outer drive chain portion 67 is located outside the vertical wall portion 89 of the outer bearing chain portion channel 72 and is configured to move along an outer surface of the vertical wall portion 89 (such as through a glide interface) when driven by the outer drive station 60. The outer bearing chain portion 69 moves within the outer bearing chain portion channel 72 to support the horizontal movement of the outer drive chain portion 67 and to support movement of the spiral stack 28. The outer bearing chain assembly 62 does not feature similar extending flanges 76 and 97 as featured in the inner bearing chain assembly 52. Additionally, an optional drip plate may be included. For example, see the outer rail drip plate 68.

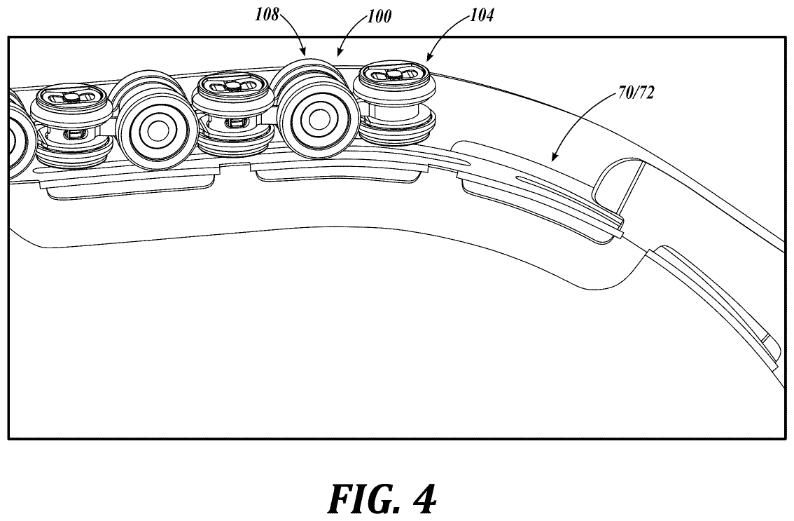

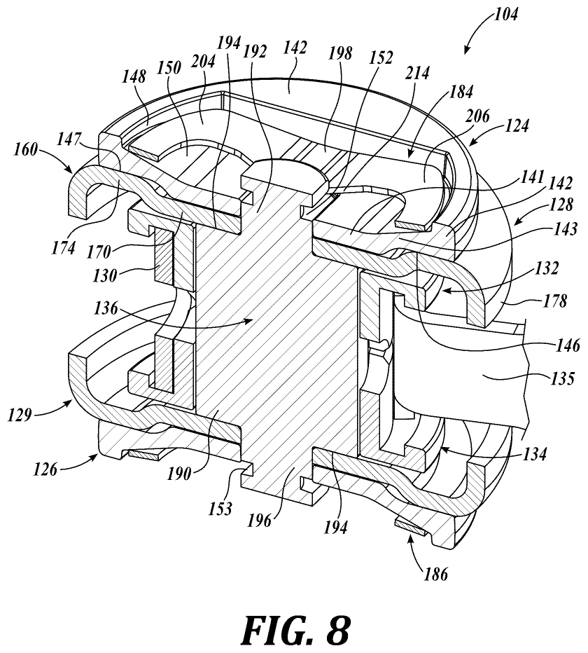

Exemplary aspects of a bearing chain assembly 100 for use as the inner bearing chain portion 59 and the outer bearing chain portion 69 will now be described with reference to FIGS. 4-11.

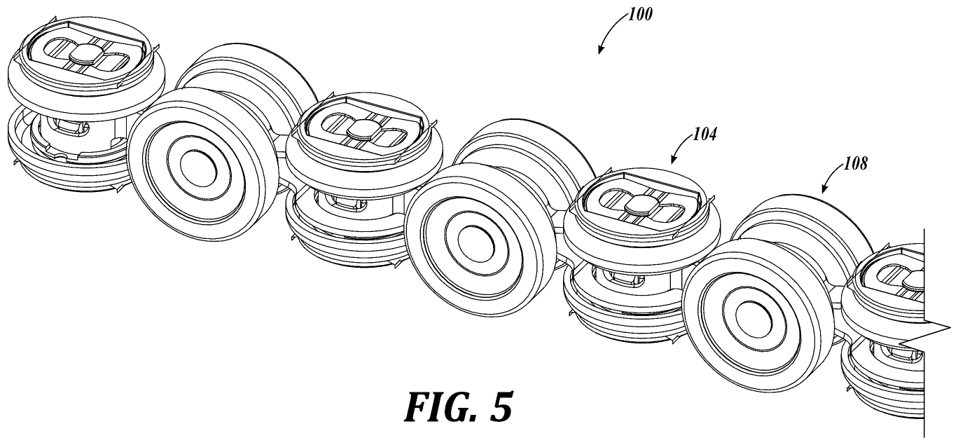

Referring first to FIGS. 4 and 5, the exemplary bearing chain assembly 100 is characterized by two types of bearings. The first bearing is a radial load bearing 104, and the second bearing is a vertical load bearing 108. The radial load bearing 104 and the vertical load bearing 108 are alternately arranged in succession to form an elongate bearing chain assembly. The rotational axes of the radial and vertical load bearings 104 and 108 are mutually orthogonal and perpendicular to the longitudinal direction of the bearing chain assembly 100. In that regard, the rotational axis of each of the radial load bearings 104 is oriented perpendicular to the rotational axis of each of the vertical load bearings 108. As will become appreciated further below, such perpendicular orientation of the rotation axes allows the radial and vertical load bearings 104 and 108 to support at least radial and vertical loads, respectively, when the drive assembly 26 is driving the spiral stack.

First and second neighboring horizontal and vertical load bearing assemblies 104 and 108 are interconnected with a linkage assembly configured to hold said neighboring horizontal and vertical load bearing assemblies 104/108 in a spaced relationship relative to each other. The linkage assembly is also configured to facilitate relative mobility between the horizontal and vertical load bearing assemblies 104/108 as the bearing chain assembly 100 moves within its bearing chain channel path.

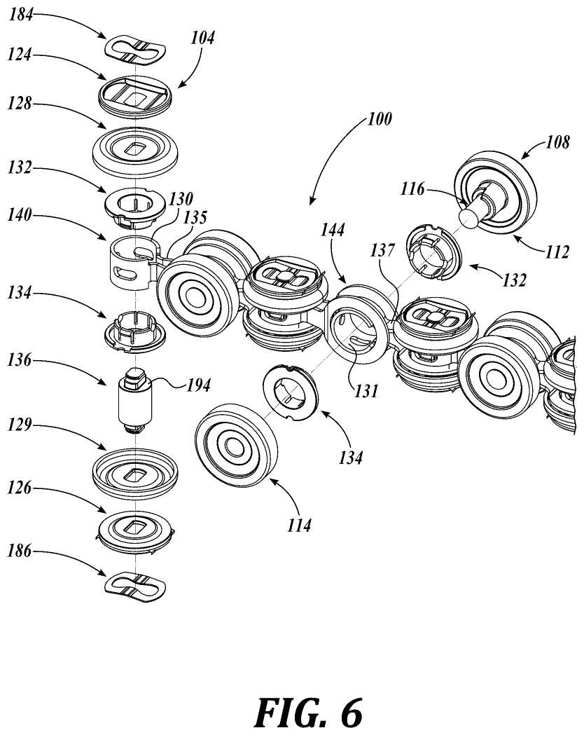

As shown in FIG. 6, the linkage assembly includes vertically oriented linkages 140 interconnected with horizontally oriented linkages 144. The vertically oriented linkages 140 are moveably secured to the radial load bearings 104, and the horizontally oriented linkages 144 are moveably secured to the vertical load bearings 108.

The vertically oriented linkages 140 each include a short, cylindrical tube 130 having a central elongated axis oriented vertically. The cylindrical tube 130 is sized and configured to rotatably receive a correspondingly shaped central portion of a radial load bearing 104 and lock into place relative to the bearing chain assembly when first and second inserts 132 and 134 are secured within the cylindrical tube 130, such as via outwardly extending clips on the inserts 132 and 134 that engage correspondingly shaped slots in the cylindrical tube 130.

The horizontally oriented linkages 144 each similarly include a short, cylindrical tube 131 having a central elongated axis oriented horizontally. The cylindrical tube 131 is sized and configured to rotatably receive a correspondingly shaped central portion of a vertical load bearing 108 and lock into place relative to the roller wheel assembly when first and second inserts 132 and 134 are secured within the cylindrical tube 131.

A first connecting strap 135 extends laterally from the cylindrical tube 130 of each vertically oriented linkage 140 and terminates in first and second flat-edged disks that are secured within the neighboring vertical load bearing 108, such as via the interface of the cylindrical tube 131 and first and second inserts 132 and 134. A second connecting strap 137 extends laterally from the cylindrical tube 131 of each horizontally oriented linkage 144 and terminates in first and second flat-edged disks that are secured within the neighboring radial load bearing 104, such as via the interface of the cylindrical tube 130 and first and second inserts 132 and 134.

The connecting straps 135 and 137 may be of a suitable length to appropriately space the radial load bearing 104 and the vertical load bearing 108 to minimize or avoid any collision of assembly components. In other words, the alternating radial and vertical load bearing assemblies 104 and 108 are prevented from contacting each other during operation, and a substantially constant spacing is substantially maintained throughout the bearing chain assembly 100 during use. The cylindrical tubes 130 and 131 made be integrally formed with the corresponding connecting straps 135 and 137 from a suitably rigid and durable material to support constrained movement of the bearing chain assembly 100 during operation, such as steel.

An overview of the vertical load bearing 108 will now be described. As noted above, the vertical load bearing 108 is configured to support vertical loads when the drive assembly 26 is driving the spiral stack. As further noted above, the vertical load bearing 108 may be substantially similar to the roller wheel assembly shown and described in the above-referenced U.S. Pat. No. 10,889,448, incorporated herein. Thus, only a brief description of the vertical load bearing 108 will be provided.

FIG. 6 displays an exploded view, wherein the individual components of a vertical load bearing 108 are shown. The vertical load bearing 108 includes a first steel, roller wheel 112 configured to engage with a second steel, roller wheel 114 having aligned rotation axes. A shaft 116 extends centrally from the first roller wheel 112 and is secured within an opening in the second roller wheel 114 in a manner to support rotation of both wheels 112 and 114. The shaft 116 receives the cylindrical tube 131 of the horizontally oriented linkage 144, as discussed above.

The inserts 132 and 134, which may be made from a low-friction material such as plastic, each feature a flanged end, which is positioned against the underside of the roller wheels 112 and 114, respectively. The inserts 132 and 134 are configured to provide a bearing surface between the roller wheels 112 and 114 and the horizontally oriented linkage 144. In this way, the inserts 132 facilitate rolling movement of the roller wheels 112 and 114 relative to the horizontally oriented linkage 144.

Detailed exemplary aspects of the radial load bearing 104 will now be described. As noted above, the radial load bearing 104 is configured to support radial loads when the drive assembly 26 is driving the spiral stack. The bearing chain assembly 100 experiences radial forces from the wrapping of the drive chain assembly 26 and the wrapping and tension imposed by the conveyor belt 34. As will further become appreciated, the radial load bearing 104 is also configured to support gliding movement of the bearing chain assembly 100 along curved surfaces of the drive assembly 26 that cannot be supported by the vertical load bearings 108. The radial load bearing 104 is configured to support such radial loads and facilitate gliding movement of the bearing chain assembly 100 along the drive and return path, all while minimizing component wear and failure.

The radial load bearing 104 generally includes a roller assembly configured to facilitate rolling of the bearing chain assembly 100 along radial surfaces of the drive path, a glide bearing assembly configured to facilitate sliding movement of the bearing chain assembly 100 along curved upper and lower surfaces of the return path, a connection assembly configured to secure the roller and bearing components relative to one another, and a synchronous-motion assembly configured to substantially maintain alignment and synchronous movement of the roller components during operation.

The roller assembly, which is configured to facilitate rolling of the bearing chain assembly 100 along radial surfaces of the drive path, will first be described. The roller assembly includes a first roller wheel 128 positioned opposite and substantially mirrored in configuration relative to a second roller wheel 129. The first and second roller wheels 128 and 129 are secured together and are spaced apart through a cylindrical through-shaft 136 extending along an axis transverse to a rotation axis of the radial load bearing 104. The through-shaft 136 facilitates substantially synchronous rotation of the wheels about a radial load roller bearing wheel rotation axis 138. The through-shaft 136 forms part of the connection assembly configured to secure the roller and bearing components relative to one another and part of the synchronous-motion assembly configured to substantially maintain alignment and synchronous movement of the roller components during operation.

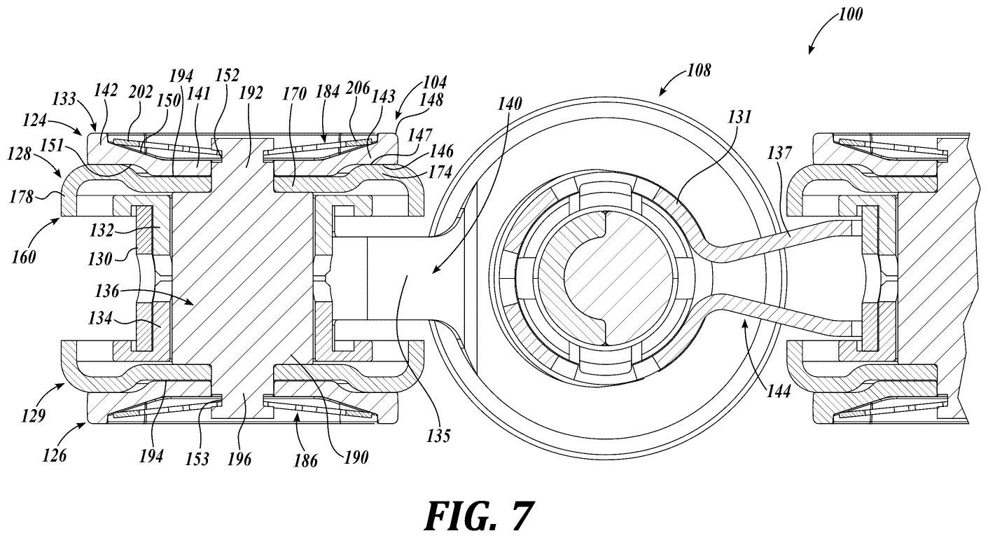

The through-shaft 136 of the radial load bearing 104 may be secured to the vertically oriented linkages 140 in a manner similar to how the vertical load bearing 108 is secured to the horizontally oriented linkages 144. For instance, first and second plastic inserts 132 and 134, identical to those described for the vertical load bearing 108, house the through-shaft 136 and moveably secure the through-shaft within the cylindrical tube 131 of the linkage. Specifically, the first and second plastic inserts 132 and 134 provide a bearing interface between the through-shaft 136 and the cylindrical tube 131. As seen in FIG. 7, the first and second plastic inserts 132 and 134 includes flanged ends that interface with the underside of the first and second roller wheels 128 and 129, respectively.

Detailed aspects of the first and second roller wheels 128 and 129 will now be provided. The first and second roller wheels 128 and 129 are substantially identical, and therefore, only the first roller wheel 128 will be described in detail. The first roller wheel 128 is generally a hollow metal structure defined by a substantially planar body 160 formed (e.g., pressed) into a wheel geometry. In that regard, a geometry of an inner surface of the first roller wheel 128 generally matches the geometry of an outer surface of the first roller wheel 128. Moreover, the thickness of the substantially planar body 160 is relatively thin. In that manner, the first roller wheel 128 is relatively lightweight and low in material cost. In some examples, however, the first roller wheel 128 may instead be defined by a solid structure.

The substantially planar body 160 of the first roller wheel 128 is shaped to define a central, substantially flat circular portion 170 extending generally transversely and radially from the rotation axis of the first roller wheel 128. The substantially flat circular portion 170 radially transitions into a raised substantially flat circumferential portion 174 extending generally transversely and radially from the rotation axis of the first roller wheel 128. In that regard, the substantially flat circular portion 170 defines a recessed circular area in the substantially planar body 160.

A radial flange 178 extends generally transversely from the raised substantially flat circumferential portion 174 towards the second roller wheel 129 with a rounded edge defined therebetween. The outer surface of the radial flange 178 defines a flat rolling surface substantially parallel to the rotation axis of the first roller wheel 128. The outer flat rolling surface of the radial flange 178 is configured to receive radial loads experienced by the radial load bearing 104 and facilitate rolling of the wheels along radial surfaces of the drive path.

The outer flat rolling surfaces defined by the radial flange 178 of the first and second wheels 128 and 129 define, in part, the synchronous-motion assembly configured to substantially maintain alignment and synchronous movement of the bearing chain assembly roller components within the inner bearing chain portion channel 70. As can be seen in FIG. 3, the outer flat rolling surfaces defined by the radial flanges 178 interface with an inner surface of the radially outer vertical wall 78 of the inner support rail 56 and the downwardly extending flanges 97 of the inner bearing chain assembly 52. The substantially flat interface between the radial flanges 178 and the corresponding surfaces of the inner bearing chain portion channel 70 help maintain alignment of the first and second wheels 128 and 129 with the rotation axis of the radial load bearing 104. Moreover, as will be discussed further below, the through-shaft 136 of the connection assembly helps secure the first roller wheel 128 relative to the second roller wheel 129. Thus, the through-shaft 136 also defines part of the synchronous-motion assembly.

The synchronous-motion assembly helps maintain contact between the substantially flat radial flanges 178 and the corresponding surfaces of the inner bearing chain portion channel 70. Previous roller wheel designs often resulted in the radial load bearing 104 tilting in certain sections of the drive path. Specifically, an edge of the wheel would engage a curved transition portion between the upper horizontally planar pitch 90 and the downwardly extending flange 97 of the inner bearing chain assembly 52. As radial forces were applied to the first roller wheel by the downwardly extending flange 97, the first roller wheel would be urged upwardly and radially inwardly. Such movement of the first roller wheel would tilt the entire bearing chain assembly about an axis transverse to the rotation axis of the radial load bearing 104 and was likely a source of high cycle fatigue due to the increased radial loads on the second roller wheel.

In the bearing chain assembly 100 described herein, the geometry of the first and second roller wheels 128 and 129 of the radial load bearing 104 are configured to substantially maintain contact between the substantially flat radial flanges 178 and the corresponding surfaces of the inner bearing chain portion channel 70 (e.g., the downwardly extending flange 97). As such, the bearing chain assembly 100 does not tilt as in the prior art design, and radial loads are distributed substantially evenly across both the first and second roller wheels 128 and 129 of the radial load bearing 104.

The first and second roller wheels 128 and 129 are also made of a suitable material to help withstand the radial and rolling forces received by the wheels. In one example, the first and second roller wheels 128 and 129 are made of steel (e.g., 304 steel). The drive path for the radial load bearing 104 within the inner bearing chain portion channel 70 and the outer bearing chain portion channel 72, as defined by the inner support rail 56, outer support rail 66, and portions of the inner and outer roller drive chain assemblies 52 and 62, is typically defined by steel. In that regard, using steel as the material for the first and second roller wheels 128 and 129 results in increased friction between the steel surfaces of the inner and outer bearing chain portion channels 70 and 72 and the wheels 128 and 129, such as compared to plastic wheels rolling on steel surfaces.

Such increased frictional interface supports rolling of the first and second roller wheels 128 and 129 rather than sliding. Rolling is advantageous as it prevents undue wear on the first and second roller wheels 128 and 129 that would occur if they were to slide. Sliding leads to excess shear force acting on the wheels 128 and 129, which results in greater wear.

Additionally, using steel for the first and second roller wheels 128 and 129 decreases the likelihood of crack propagation in the wheels due to its material properties. Plastic wheels, as used with prior art designs, are typically manufactured via injection molding, which creates a weld line where the molds meet. Crack propagation or rolling fatigue can occur at the weld line, in addition to other areas of the plastic wheel. Using steel for the first and second roller wheels 128 and 129 substantially resolves the issue of crack propagation. Steel is better equipped to handle radial loads experienced by the radial load bearing 104, which helps to decrease overall crack propagation and wear on the first and second roller wheels 128 and 129.

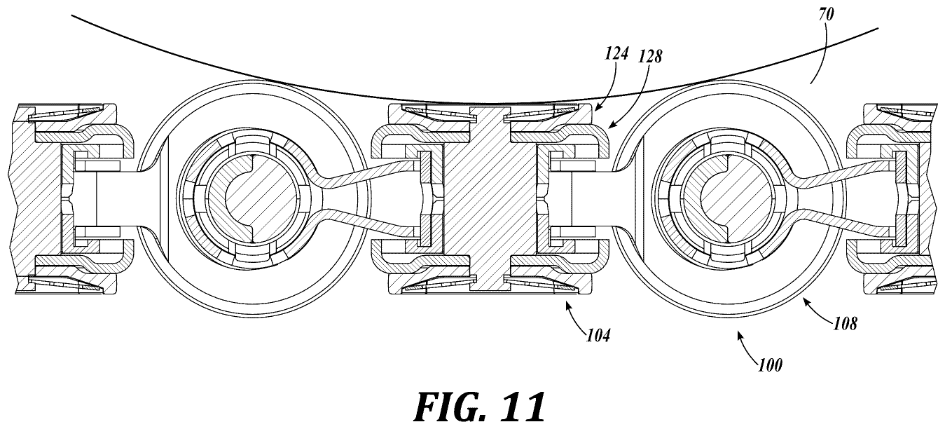

Using steel for the first and second roller wheels 128 and 129 helps support rolling of the wheels within the inner bearing chain portion channel 70 and helps withstand the radial and rolling forces received by the wheels, as discussed above. However, upper and lower surfaces of the radial load bearing 104 often need to glide along curved portions of the inner bearing chain portion channel 70. For instance, FIG. 11 shows an exemplary curved portion of the inner bearing chain portion channel 70. As can be seen, an upper, outer end of the first roller wheel 128 engages the curved surface of the inner bearing chain portion channel 70 as the radial load bearing 104 passes through the curved section.

Prior art designs used plastic roller wheels to support such gliding. As can be appreciated, a plastic wheel would slide relatively easily along the steel surface of the inner bearing chain portion channel 70. By contrast, a steel wheel, such as the steel first or second roller wheel 128 or 129, would not slide easily as there is greater friction between steel components. In that regard, and as noted above, the radial load bearing 104 includes a glide bearing assembly configured to facilitate sliding movement of the bearing chain assembly 100 along curved upper and lower surfaces of the return path.

The glide bearing assembly is generally defined by first and second glide bearings 124 and 126 secured to the outer surfaces of the first and second roller wheels 128 and 129. Thus, the first and second glide bearings 124 and 126 are located on the first and second roller wheels 128 and 129 such that they are between the first and second roller wheels 128 and 129 and any curved upper and lower surfaces of the return path during operation. In that regard, the first and second glide bearings 124 and 126 are configured to facilitate gliding of the radial load bearing 104 along curved portions of the return path with minimal friction. It should be appreciated that the first and second glide bearings 124 and 126 are also configured to facilitate gliding of the radial load bearing 104 along curved upper and lower surfaces of the drive path in applicable systems. Thus, reference to “return path”may be generally understood to include the drive path, and vice versa.

The first and second glide bearings 124 and 126 are substantially identical; and therefore, only the first glide bearing 124 will be described in detail. The first glide bearing 124 has a glide bearing body 133 that is generally circular in shape and has a geometry configured to lockingly engage with the first roller wheel 128. In other words, the glide bearing body 133 is sized and shaped to engage the substantially flat circular portion 170 and the raised substantially flat circumferential portion 174 of the first roller wheel 128. In the depicted example, the glide bearing body 133 has a diameter that is substantially equal to the combined diameter of the substantially flat circular portion 170 and the raised substantially flat circumferential portion 174 of the first roller wheel 128.

However, the diameter of the glide bearing body 133 is less than the overall diameter of the first roller wheel 128 so as to not interfere with rolling action of the first roller wheel 128. For instance, as can be seen in FIG. 7, the radial flange 178 of the first roller wheel 128 protrudes radially from the outer edge of the glide bearing body 133. This configuration also substantially avoids any stress concentration points and/or cyclic loading on the glide bearing during the rolling action of the bearing chain assembly 100.

As noted above, the glide bearing body 133 has a geometry that enables the glide bearing body 133 to be somewhat secured within the recessed first roller wheel 128 and positively locked in substantially the center of the first roller wheel. For instance, in the example shown, the glide bearing body 133 includes a substantially flat circular portion 141 that is generally the same size or diameter as the substantially flat circular portion 170 of the first roller wheel 128.

The substantially flat, first circular bottom portion 141 of the glide bearing body 133 radially transitions into a raised, circumferential flattened glide portion 142. The raised, circumferential flattened glide portion 142 defines a glide bearing surface of the first glide bearing 124. Specifically, the raised, circumferential flattened glide portion 142 defines a substantially flat, horizontal outer circumferential surface 148 that is configured to engage and glide along the curved surfaces of the return path with minimal friction (see FIG. 11).

The raised circumferential flattened glide portion 142 of the glide bearing body 133 is substantially axially aligned with the raised substantially flat circumferential portion 174 of the first roller wheel 128. As such, a bottom, substantially flat surface 146 of the raised circumferential flattened glide portion 142 of the glide bearing body 133 lays against an upper, substantially flat surface 147 of the raised substantially flat circumferential portion 174 of the first roller wheel 128. Loads imposed on the raised circumferential flattened glide portion 142 of the first glide bearing 124 may be transferred to the radial load bearing 104 through the raised substantially flat circumferential portion 174 of the first roller wheel 128.

The first glide bearing 124 is made from a suitable material to facilitate gliding while enduring frictional and radial loads imposed during the gliding movement. For instance, the first glide bearing 124 is made of a suitable plastic having a low frictional coefficient, thus supporting gliding rather than gripping. In some examples, the first glide bearing 124 is made of POM-C plastic, which can be less susceptible to cracks than other plastics such as PA12 nylon. For instance, POM-C can be made from processes and/or materials selected to absorb less water in 50% RH than PA12 nylon. Water absorbed into small impurities developed within the glide bearing can cause cracks when the temperature goes below freezing. Thus, POM-C plastic can be less susceptible to cracks than PA12 nylon or similar materials. Although POM-C may be more susceptible to wear than some plastics, such as PA12 nylon, the exposure to wearing forces is minimized in the present bearing chain assembly 100 by using steel wheels for rolling and a separate glide bearing for gliding. In any event, the material of the first glide bearing 124 is preferably suitable for the low temperatures of an industrial freezer (e.g., down to −40°C), but other materials may be used for other environments.

The first and second glide bearings 124 and 126 are secured to the first and second roller wheels 128 and 129, respectively, such that they rotate and move with the roller wheels through the drive and return paths. As noted above, the radial load bearing 104 includes a connection assembly configured to secure the bearing components relative to one another, and a synchronous-motion assembly configured to substantially maintain alignment and synchronous movement of the bearing components during operation. Detailed exemplary aspects of the connection assembly and the synchronous-motion assembly will now be described.

In one aspect, the connection assembly and the synchronous-motion assembly include the through-shaft 136, referenced above, which extends centrally through the radial load bearing 104. The through-shaft 136 is configured to extend through centrally aligned openings in the first and second roller wheels 128 and 129 and the first and second glide bearings 124 and 126. First and second biasing devices, such as first and second spring clips 184 and 188 are secured to first and second protruding ends of the through-shaft 136, respectively, for securing the components together and biasing them towards one another.

In the depicted example, the through-shaft 136 includes a central cylindrical body 190 having a first diameter and first and second protruding cylindrical end portions 192 and 196 having a second diameter smaller than the first diameter of the central cylindrical body 190. The change in diameter from the central cylindrical body 190 to the first and second cylindrical protruding end portions 192 and 196 occurs at a substantially 90-degree angle, thereby defining a substantially flat contact surface 194 at each of the first and second ends of the central cylindrical body 190. The substantially flat contact surface 194 at each of the first and second ends of the central cylindrical body 190 is configured to engage and support the inner surface of the substantially flat circular portion 170 of each wheel 128 and 129, respectively.

The first and second cylindrical protruding end portions 192 and 196 of the through-shaft 136 are configured to protrude through the openings in the first and second glide bearings 124 and 126 to receive the first and second spring clips 184 and 186, respectively. When the first and second spring clips 184 and 186 are secured to the first and second cylindrical protruding end portions 192 and 196, the spring clips impose a pressing force against the inclined outer surface of the first and second glide bearings 124 and 126, locking the components of the radial load bearing 104 in place. The manner in which the first and second spring clips 184 and 186 engage each respective cylindrical protruding end portion 192 and 196 is identical. Therefore, only a detailed description of how the first spring clip 184 engages the first cylindrical protruding end portion 192 of the through-shaft 136 will be provided.

In the depicted example, the first spring clip 184 is configured to engage a first circumferential notch 152 defined in the first cylindrical protruding end portion 192 of the through-shaft 136. The first circumferential notch 152 is located axially along the first cylindrical protruding end portion 192 such that when a center portion of the first spring clip 184 is deformed into engagement with the notch, first and second lateral end portions of the first spring clip impose a sufficient pressing or compressive force on the outer surface of the first glide bearing 124. The second spring clip 186 is configured to engage a second circumferential notch 153 defined in the second cylindrical protruding end portion 196 of the through-shaft 136 in substantially the same manner.

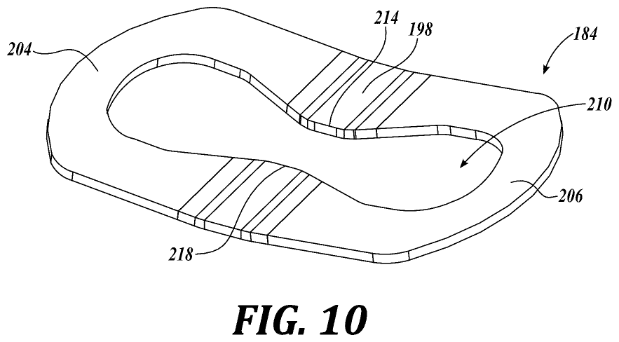

FIG. 10 shows exemplary details of the first spring clip 184. The first spring clip 184 has a generally oblong planar body having a central portion 198 and first and second opposing lateral end portions 202 and 206. A substantially centered elongated opening 210 extends along the length of the oblong planar body that has a shape similar to the oblong planar body, with the exception that at the central portion 198, the elongated opening 210 narrows in width to define first and second notch-engaging portions 214 and 218. In that regard, the elongated opening 210 somewhat resembles a dog-bone shape.

The first and second notch-engaging portions 214 and 218 of the first spring clip 184 are configured to engage opposite sides of the circumferential notch 152 in the first cylindrical protruding end portion 192 of the through-shaft 136. To facilitate such engagement, the spring clip 184 is sized and configured to be received within the recessed portion of the glide bearing body 133 defined by the substantially flat, circular portion 141. The recessed portion of the glide bearing body 133 is sufficiently deep such that an upper surface of the first cylindrical protruding end portion 192 sits below the level of the gliding contact surface of the first glide bearing 124 (and specifically, the circumferential flattened glide portion 142). In this manner, the first cylindrical protruding end portion 192 does not interfere with gliding action of the glide bearing.

As may best be seen by referring to FIG. 7, the glide bearing body 133 includes an intermediate radial portion 143 extending between the central, circular portion 141 and the raised, circumferential flattened glide portion 142. The intermediate radial portion 143 defines an outer, radially inclined surface 150 that inclines upwardly as it extends radially outwardly towards the circumferential flattened glide portion 142. In this manner, when the first and second notch-engaging portions 214 and 218 of the first spring clip 184 are moved into engagement with the circumferential notch 152, the outer, radially inclined surface 150 of the intermediate radial portion 143 forces the first and second lateral end portions 202 and 206 to deform upwardly and impose a downward compressive force on the first glide bearing 124 (note that the first spring clip 184 is shown in at least a partially deformed state in all the FIGS.). In that regard, only the first and second opposing lateral end portions 202 and 206 of the spring clip 184 substantially contact and impose a force on the first glide bearing 124.

The intermediate radial portion 143 includes a bottom, substantially flat annular surface 151 opposite the outer, radially inclined surface 150. The bottom, substantially flat annular surface 151 extends from and is substantially co-planar with the bottom, substantially flat surface 146 of the raised circumferential flattened glide portion 142 of the glide bearing body 133. The bottom, substantially flat annular surface 151 of the intermediate radial portion 143 lays against the upper, flat surface of the raised substantially flat circumferential portion 174 of the first roller wheel 128 when the first glide bearing 124 is secured to the first roller wheel. In this manner, loads imposed by the first spring clip 184 against the intermediate radial portion 143 are transferred to the first roller wheel 128 through the raised substantially flat circumferential portion 174.

A gap or freeplay is defined between a bottom surface of the circular portion 141 of the first glide bearing 124 and a top surface of the substantially flat circular portion 170 of the first roller wheel 128. Such a gap helps ensure that all loads imposed by the first spring clip 184 against the intermediate radial portion 143 are transferred to the first roller wheel 128 through the raised substantially flat circumferential portion 174.

The downward compressive force applied by the first spring clip 184 on the first glide bearing 124 prevents the radial load bearing 104 from separating and secures the individual components in place when the second spring clip 188 provides an opposing force on the second glide bearing 126 in the same manner. To disassemble the radial load bearing 104, the first spring clip 184 (and/or the second spring clip 186) may disengaged from the notch 152, and the individual components can be separated.

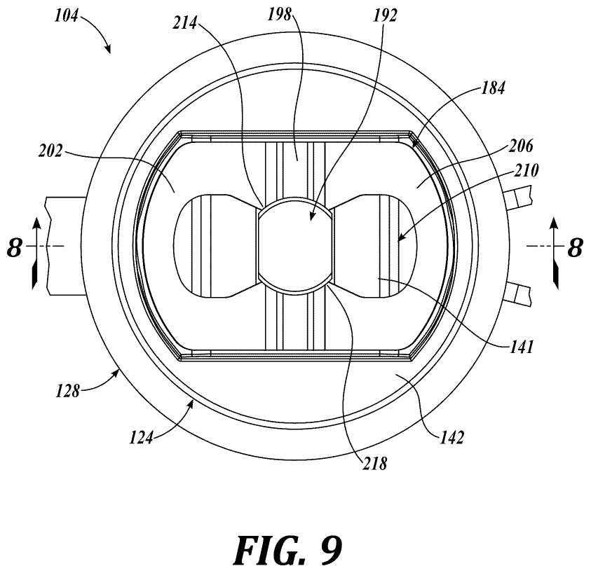

The first cylindrical protruding end portion 192 of the through-shaft 136 is configured to engage and oppose the force of the first spring clip 184 without imposing high stress points in the clip. Points of high stress can lead to cracks and failure in the spring clip, as in prior art designs. In the example shown, a curved outer edge extends along the circumferential notch 152 of the first cylindrical protruding end portion 192 (see FIG. 9 which shows the curvature of the upper outer edge of the first cylindrical protruding end portion 192, which mirrors the lower outer edge). The curved edge extends along the portion of the notch 152 that engages the first and second notch-engaging portions 214 and 218 of the first spring clip 184. In this manner, a sharp edge that could lead to cracks and failure is avoided.

Further aspects of the connection assembly and the synchronous-motion assembly include a rotational constraint between the through-shaft 136, the first and second roller wheels 128 and 129, and the first and second glide bearings 124 and 126. More specifically, the through-shaft 136 is received within the first and second roller wheels 128 and 129 and the first and second glide bearings 124 and 126 such that they cannot rotate individually. Rather, the through-shaft 136, first and second roller wheels 128 and 129, and the first and second glide bearings 124 and 126 rotate substantially in unison.

A suitable locking interface is defined between the through-shaft 136 and the first and second roller wheels 128 and 129 and first and second glide bearings 124 and 126 to rotationally constrain the components. In the depicted example, the first and second cylindrical protruding end portions 192 and 196 each include flattened, truncated opposing sides extending axially along the end portion. Central openings in the first and second roller wheels 128 and 129 and first and second glide bearings 124 and 126 are correspondingly shaped (e.g., the openings are circular with flattened opposing sides) to mate with the circular, truncated cross-sectional shape of the first and second cylindrical protruding end portions 192 and 196.

The openings in the first and second roller wheels 128 and 129 and first and second glide bearings 124 and 126 are also substantially the same cross-sectional size of the first and second cylindrical protruding end portions 192 and 196. In that regard, the first and second cylindrical protruding end portions 192 and 196 of the through-shaft 136 are configured to fit with little clearance into the openings in the first and second wheels 128 and 129 and the first and second glide bearings 124 and 126. In this manner, when the wheels 128 and 129 rotate, the through-shaft 136 forces substantially synchronous motion of the first and second roller wheels 128 and 129 and first and second glide bearings 124 and 126 of the radial load bearing 104. The cylindrical through-shaft 136 may be made from a suitable material to withstand forces imposed by the first and second roller wheels 128 and 129, such as steel.

The synchronous-motion assembly, including the connection assembly, rotationally constrains the first and second roller wheels 128 and 129 relative to the through-shaft 136. In that regard, the first and second roller wheels 128 and 129 rotate substantially in unison. In previous designs using plastic wheels, slippage occurred between the wheels, causing a rotation angle offset of the wheel pair. Also, as noted above, previous designs caused the first roller wheel to be urged upwardly and inwardly as radial forces were applied to the first roller wheel, separating the first roller wheel from the second roller wheel. Separation of the roller wheels caused the lateral ends of the spring clips to bend at a greater angle than they had been designed to bend. The wheel slippage and vertical separation resulted in fatigue stress and cyclic loading on the spring clip, leading to crack propagation, especially at the sharp edges of mating surfaces. Crack propagation weakens the spring clip and threatens the integrity of the bearing chain assembly.

The radial load bearing 104 of the present disclosure has addressed this issue by utilizing the synchronous-motion assembly, including the connection assembly, to rotationally constrain the first and second roller wheels 128 and 129 relative to the through-shaft 136. The first and second roller wheels 128 and 129 are forced to roll substantially synchronously and in axial alignment. Further, the wheel design of the radial load bearing 104 prevents vertical wheel separation. Rather, the outer surfaces of the radial flange 178 of both the first and second roller wheels 128 and 129 stay engaged with the radial surfaces of the drive path during rolling. Synchronous rolling results in radial loads acting concurrently on both the first and second wheels 128, further resulting in a symmetric load on the through-shaft 136. A symmetric load prevents the bearing chain assembly 100 from twisting and reduces cyclic loading on the spring clip and other components. In fact, using computer-aided analysis, the inventors found that no remarkable stress loads are expected using the spring clip design described herein. Thus, the various design improvements over the prior art, as disclosed herein, reduce excess wear and cyclic loading experienced by a bearing chain assembly within the drive and return assembly of spiral conveyor belt systems.

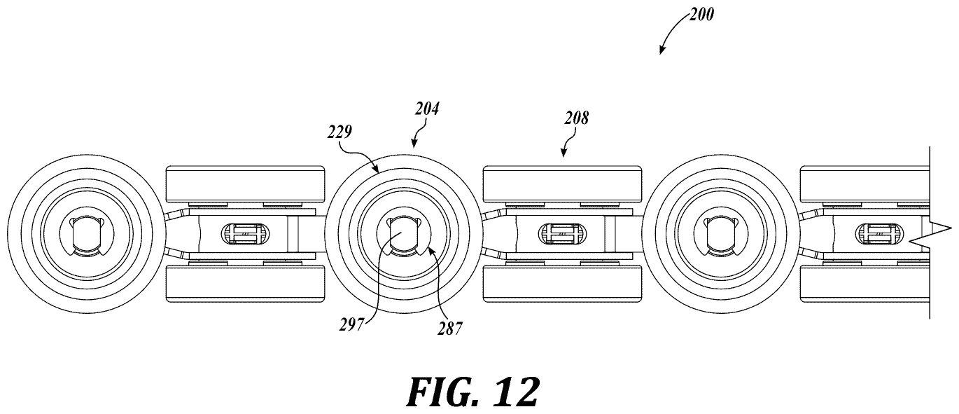

Referring to FIGS. 12-14, an alternative example of a radial load bearing 204 for use in a bearing chain assembly 200 will now be described. The radial load bearing 204 is substantially identical to the radial load bearing 104 described above, with the exception that the radial load bearing 204 is adapted to include only one glide bearing. For instance, the second glide bearing is excluded. Moreover, the bearing chain assembly 200 is substantially identical to the bearing chain assembly 100 described above (e.g., it includes interconnected radial load bearings 204 and vertical load bearings 208 having transverse roller axes), with the exception of the radial load bearing 204. In that regard, like parts have been labeled with the same reference numeral, except in the '200 series. Moreover, for brevity, only detailed aspects of the radial load bearing 204 that have been modified from the radial load bearing 104 to support exclusion of the second glide bearing will be described.

The radial load bearing 204 includes first and second roller wheels 228 and 229 secured together in a spaced apart, parallel relationship. The first and second roller wheels 228 and 229 are secured to a through-shaft 236 extending along an axis transverse to the rotation axis of the radial load bearing 204.

The through-shaft 236 includes a central cylindrical body 290 having a first diameter and first and second protruding cylindrical end portions 292 and 296 having a second diameter smaller than the first diameter of the central cylindrical body 290. The change in diameter from the central cylindrical body 290 to the first and second cylindrical protruding end portions 292 and 296 occurs at a substantially 90-degree angle, thereby defining a substantially flat contact surface 294 at each of the first and second ends of the central cylindrical body 290. The substantially flat contact surface 294 at each of the first and second ends of the central cylindrical body 290 is configured to engage and support an inner substantially flat surface of the first and second roller wheels 128 and 129, respectively.

The first roller wheel 228 is secured to the first cylindrical protruding end portion 292 with a first spring clip 284. A first glide bearing 224 is disposed between the first spring clip 284 and the first roller wheel 228, like that described above for radial load bearing 104. In that regard, the first spring clip 284 is received within a first circumferential notch 252 of the first cylindrical protruding end portion 292 to axially secure the first roller wheel 228 and first glide bearing 224 to the through-shaft 236.

The second roller wheel 229 is secured to the second cylindrical protruding end portion 296 of the through-shaft 236 with a second spring clip 287. The second spring clip 287 is received within a second circumferential notch 253 of the second cylindrical protruding end portion 297 to axially secure the second roller wheel 229 to the through-shaft 236. However, no glide bearing is disposed between the second spring clip 287 and the second roller wheel 229. In that regard, the second circumferential notch 253 on the second cylindrical protruding end portion 297 is located axially closer to the first roller wheel 228 than the second circumferential notch 253 on the second cylindrical protruding end portion 196 of radial load bearing 104. The second cylindrical protruding end portion 297 may be smaller in axial length than the axial length of the first cylindrical protruding end portion 292 to axially position the second circumferential notch 253 closer to the first roller wheel 228.

The second spring clip 287 may be of a different configuration than the first spring clip 284 to account for the excluded glide bearing. Specifically, the second spring clip 287 may be configured to secure the second roller wheel 229 to the through-shaft 236 without the use of a glide bearing therebetween.

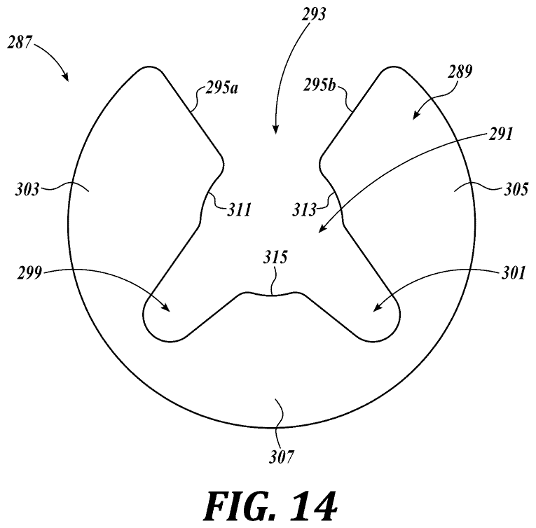

FIG. 14 shows exemplary details of the second spring clip 287. In the depicted example, the second spring clip 287 has a substantially circular, flattened body 289 with a central circular opening 291. The central circular opening 291 is configured to receive the second cylindrical protruding end portion 297 of the through-shaft 236 at the second circumferential notch 253. In that regard, the central circular opening 291 may have substantially the same diameter as the outer surface of the second cylindrical protruding end portion 297 at the second circumferential notch 253.

A first radial opening 293 extends between the central circular opening 291 and an outer circumferential edge of the flattened body 289, generally giving the second spring clip 287 an overall C-shape. The first radial opening 293 includes first and second radial edges 295a and 295b extending generally along first and second radiuses of the flattened body 289 on each side of the radial opening 293. The first and second radial edges 295a and 295b are sufficiently spaced to allow the second cylindrical protruding end portion 297 at the second circumferential notch 253 to move into engagement with the central circular opening 291.

A first radial recess 299 extends from the central circular opening 291 generally diametrically opposite the second radial edge 295b, and a second radial recess 301 extends from the central circular opening 291 generally diametrically opposite the first radial edge 295a. The first and second radial recesses 299 and 301 are configured to define first and second flattened, generally pie-shaped body portions 303 and 305 on each side of the central circular opening 291 with a third flattened, generally pie-shaped body portion 307 extending therebetween. The second spring clip 287 is configured to engage an annular, axially-extending surface of the second circumferential notch 253 at first, second, and third circumferential edges 311, 313, and 315 of each of the flattened body portions 303, 305, and 307, respectively, at the central circular opening 291.

The first and second radial recesses 299 and 301 can facilitate deformation of the first and second flattened body portions 303 and 305 relative to the third flattened body portion 307 if needed for applying a pressing force to the second roller wheel 229 and/or for engaging the second spring clip 287 with the second circumferential notch 253. In that regard, each of the first and second radial recesses 299 and 301 may be defined by first and second radial edges interconnected by a curved bottom edge to avoid any sharp edges that cause crack propagation in the clip if one or more of the flattened body portions 303, 305, and 307 deform relative to one another.

It should be appreciated that any suitable second clip design may be used. Moreover, other types of connection assemblies may be used in addition to or instead of a second spring clip 287. For instance, the second roller wheel 229 may be secured to the second cylindrical protruding end portion 297 of the through-shaft 236 with laser welding, roll riveting, press riveting, etc.

The radial load bearing 204 supports gliding movement of the bearing chain assembly 200 along a curved upper or lower surface of a return path of a drive system. In some return paths, gliding movement is only needed along one of a curved upper or lower surface. In that regard, the bearing chain assembly 200 may be positioned within the return path channel so that the first glide bearing 224 can engage and glide along the upper or lower curved surface where needed. By comparison, the bearing chain assembly 100 is used in systems where gliding movement is needed along both of the curved upper and lower surfaces.

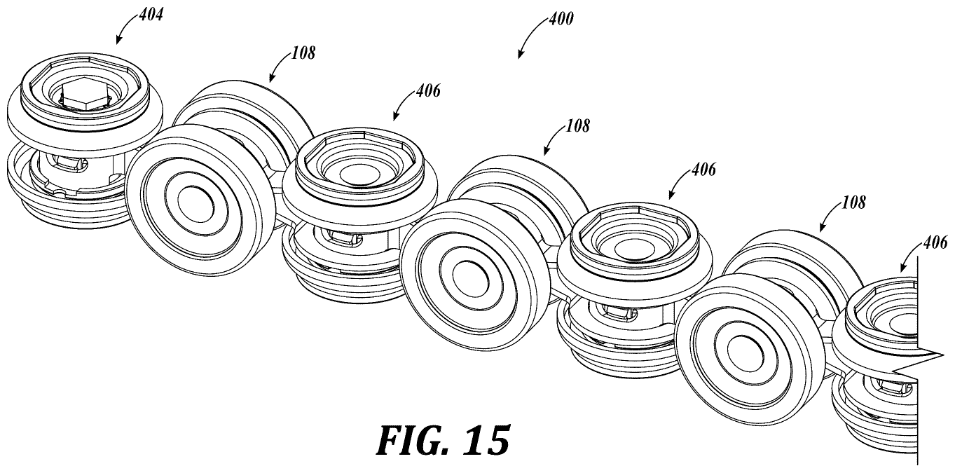

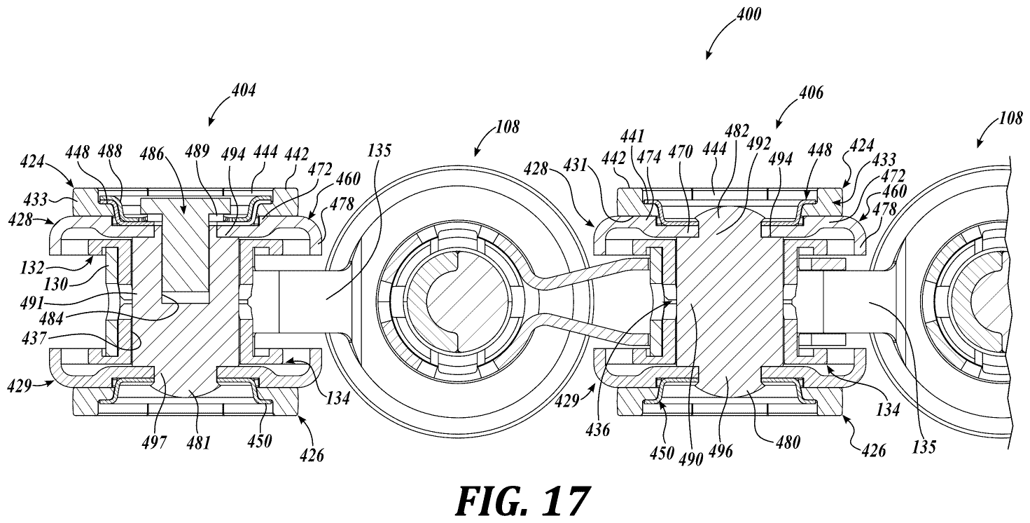

An alternative example of a bearing chain assembly 400 for use as the inner bearing chain portion 59 and the outer bearing chain portion 69 will now be described with reference to FIGS. 15-19. The bearing chain assembly 400 is substantially identical to the bearing chain assembly 100 except that it includes radial load bearings that differ from the radial load bearing 104. More specifically, the bearing chain assembly 400 includes a chain connection radial load bearing 404 and a chain element radial load bearing 406. The radial load bearings 404 and 406 of the bearing chain assembly 400 are alternately arranged with vertical load bearings 108. The vertical load bearings 108 of the bearing chain assembly 400 are identical to the vertical load bearings 108 of the bearing chain assembly 100. Thus, only the radial load bearings 404 and 406 of the bearing chain assembly 400 will be described in detail.

Generally, the chain connection radial load bearing 404 is configured for connecting opposite ends of the bearing chain assembly 400 to assemble the bearing chain assembly 400 as a continuous endless loop, and the chain element radial load bearing 406 is configured for defining a radial load chain element of the bearing chain assembly 400. In that regard, the bearing chain assembly 400 may include only a few or even just a single chain connection radial load bearing 404 for defining the bearing chain assembly 400 as a continuous endless loop, and most of the radial load bearings of the bearing chain assembly 400 may be defined as chain connection radial load bearings 406.

Both the chain connection radial load bearing 404 and the chain element radial load bearing 406 are configured to support radial loads when the drive assembly 26 is driving the spiral stack while supporting gliding movement of the bearing chain assembly 400 along curved surfaces of the drive assembly 26 that cannot be supported by the vertical load bearings 108, like the radial load bearing 104. The bearing chain assembly 400 experiences radial forces from the wrapping of the drive chain assembly 26 and the wrapping and tension imposed by the conveyor belt 34, as discussed above for the bearing chain assembly 100. The radial load bearing 404 is configured to support such radial loads and facilitate gliding movement of the bearing chain assembly 400 along the drive and return path, all while minimizing component wear and failure. In fact, in some applications, and as will be described further below, the bearing chain assembly 400 can better withstand cyclic loads when compared to the bearing chain assembly 100.

Detailed exemplary aspects of the chain element radial load bearing 406 will first be described with reference to FIGS. 15-17, 18A, and 19A. The chain element radial load bearing 406 generally includes a roller assembly configured to facilitate rolling of the bearing chain assembly 400 along radial surfaces of the drive path, a glide bearing assembly configured to facilitate sliding movement of the bearing chain assembly 400 along curved upper and lower surfaces of the return path, a connection assembly configured to secure the roller and bearing components relative to one another, and a synchronous-motion assembly configured to substantially maintain alignment and synchronous movement of the roller components during operation.

The roller assembly, which is configured to facilitate rolling of the bearing chain assembly 400 along radial surfaces of the drive path, will first be described. The roller assembly includes a first roller wheel 428 positioned opposite and substantially mirrored in configuration relative to a second roller wheel 429. The first and second roller wheels 428 and 429 are secured together and are spaced apart through a cylindrical through-shaft 436 extending along an axis transverse to a rotation axis of the chain element radial load bearing 406. The through-shaft 436 facilitates substantially synchronous rotation of the wheels about a radial load roller bearing wheel rotation axis 438. The through-shaft 436 forms part of the connection assembly configured to secure the roller and bearing components relative to one another and part of the synchronous-motion assembly configured to substantially maintain alignment and synchronous movement of the roller components during operation.

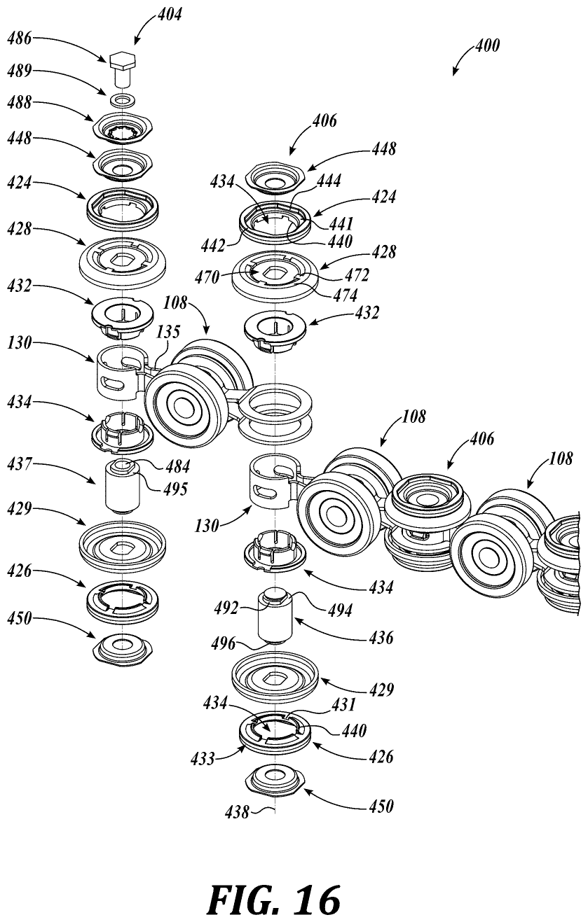

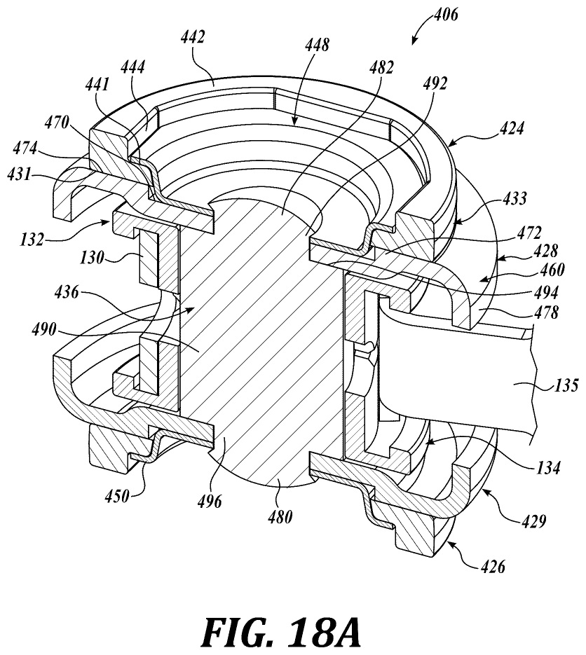

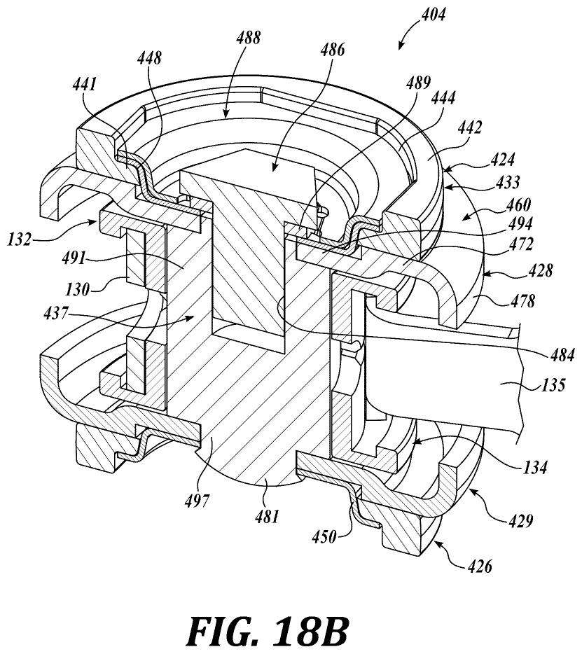

The through-shaft 436 of the chain element radial load bearing 406 may be secured to the vertically oriented linkages 140 in a manner similar to how the vertical load bearing 108 is secured to the horizontally oriented linkages 144. For instance, first and second plastic inserts 132 and 134, identical to those described for the bearing chain assembly 100, house the through-shaft 436 and moveably secure the through-shaft within the cylindrical tube 131 of the linkage. Specifically, the first and second plastic inserts 132 and 134 provide a bearing interface between the through-shaft 436 and the cylindrical tube 131. As seen in FIGS. 16 and 18A, the first and second plastic inserts 132 and 134 include flanged ends that interface with the underside of the first and second roller wheels 428 and 429, respectively.

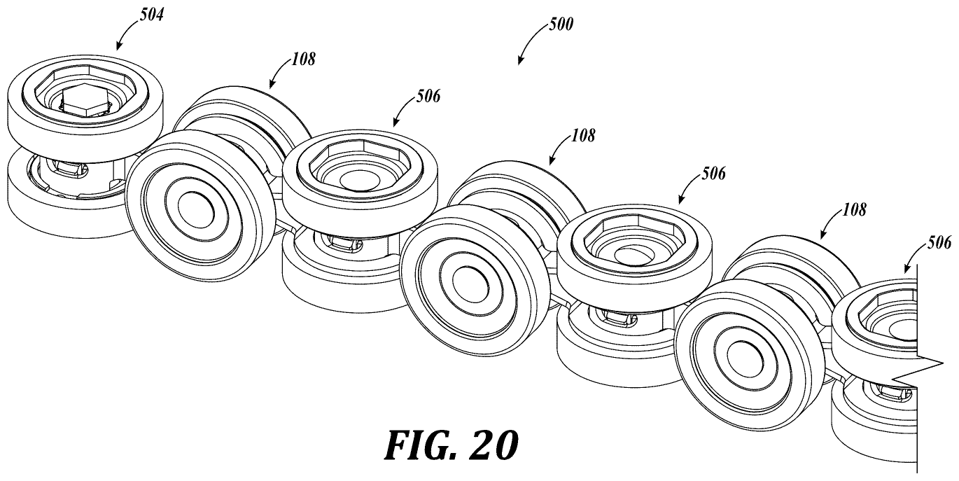

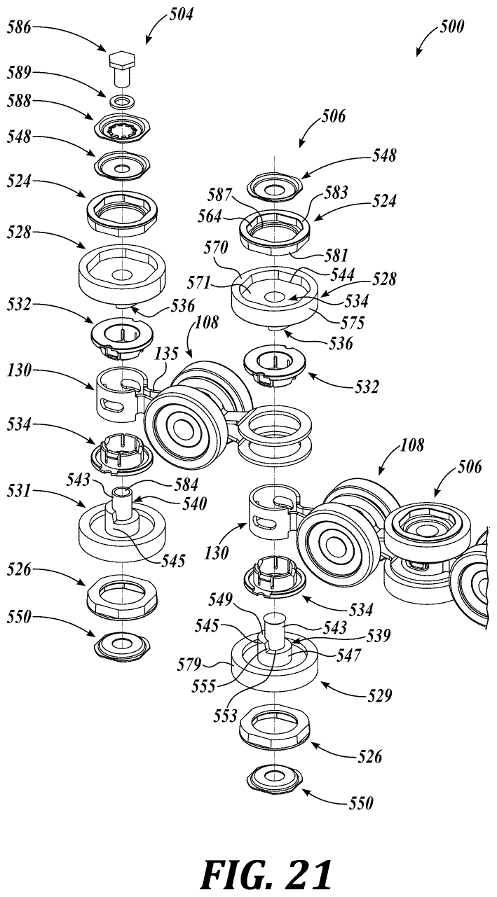

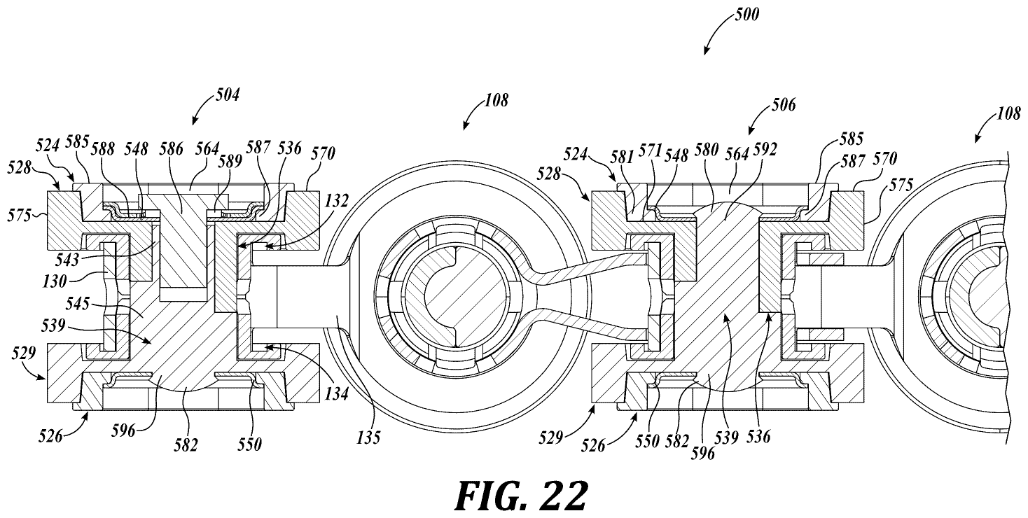

Detailed aspects of the first and second roller wheels 428 and 429 will now be provided. The first and second roller wheels 428 and 429 are substantially identical, and therefore, only the first roller wheel 428 will be described in detail. The first roller wheel 428 is generally a hollow metal structure defined by a substantially planar body 460 formed (e.g., pressed) into a wheel geometry and has a substantially similar geometry to the first roller wheel 128 described above. In that regard, a geometry of an inner surface of the first roller wheel 428 generally matches the geometry of an outer surface of the first roller wheel 428, with the exception noted below. Moreover, the thickness of the substantially planar body 460 is relatively thin. In that manner, the first roller wheel 428 is relatively lightweight and low in material cost. In some examples, however, the first roller wheel 428 may instead be defined by a solid structure, such a casted wheel, as described with reference to FIGS. 20-24.

The substantially planar body 460 of the first roller wheel 428 is shaped to define a central, substantially flat circular portion 470 extending generally transversely and radially from the rotation axis of the first roller wheel 428. The substantially flat circular portion 470 is centered within a raised substantially flat circumferential portion 474 extending generally transversely and radially from the rotation axis of the first roller wheel 428. The substantially flat circular portion 470 radial transitions into the raised substantially flat circumferential portion 474 like it does for the first and second roller wheels 128 and 129. However, horizontally extending roller wheel tabs 472 are spaced circumferentially about the radial transition area between the flat circular portion 470 and the raised substantially flat circumferential portion 474. In the depicted example, and as best seen in FIG. X, four roller wheel tabs 472 are located substantially equidistant about the circumference of the radial transition area.

A radial flange 478 extends generally transversely from the raised substantially flat circumferential portion 474 towards the second roller wheel 429 with a rounded edge defined therebetween. The outer surface of the radial flange 478 defines a flat rolling surface substantially parallel to the rotation axis of the first roller wheel 428. The outer flat rolling surface of the radial flange 478 is configured to receive radial loads experienced by the radial load bearing 404 and facilitate rolling of the wheels along radial surfaces of the drive path.

The outer flat rolling surfaces defined by the radial flange 478 of the first and second wheels 428 and 429 define, in part, the synchronous-motion assembly of the bearing chain assembly 400 configured to substantially maintain alignment and synchronous movement of the bearing chain assembly roller components within the inner bearing chain portion channel 70. The outer flat rolling surfaces defined by the radial flanges 478 interface with an inner surface of the radially outer vertical wall 78 of the inner support rail 56 and the downwardly extending flanges 97 of the inner bearing chain assembly 52. The substantially flat interface between the radial flanges 478 and the corresponding surfaces of the inner bearing chain portion channel 70 help maintain alignment of the first and second wheels 428 and 429 with the rotation axis of the chain element radial load bearing 406. Moreover, as will be discussed further below, the through-shaft 436 of the connection assembly helps secure the first roller wheel 428 relative to the second roller wheel 429. Thus, the through-shaft 436 also defines part of the synchronous-motion assembly for the bearing chain assembly 400.

The synchronous-motion assembly helps maintain contact between the substantially flat radial flanges 478 and the corresponding surfaces of the inner bearing chain portion channel 70. Previous roller wheel designs often resulted in a radial load bearing tilting in certain sections of the drive path. Specifically, an edge of the wheel would engage a curved transition portion between the upper horizontally planar pitch 90 and the downwardly extending flange 97 of the inner bearing chain assembly 52. As radial forces were applied to the first roller wheel by the downwardly extending flange 97, the first roller wheel would be urged upwardly and radially inwardly. Such movement of the first roller wheel would tilt the entire bearing chain assembly about an axis transverse to the rotation axis of the radial load bearing and was likely a source of high cycle fatigue due to the increased radial loads on the second roller wheel.

In the bearing chain assembly 400 described herein, the geometry of the first and second roller wheels 428 and 429 of the chain element radial load bearing 406 are configured to substantially maintain contact between the substantially flat radial flanges 478 and the corresponding surfaces of the inner bearing chain portion channel 70 (e.g., the downwardly extending flange 97). As such, the bearing chain assembly 400 does not tilt as in the prior art design, and radial loads are distributed substantially evenly across both the first and second roller wheels 428 and 429 of the chain element radial load bearing 406.

The first and second roller wheels 428 and 429 are also made of a suitable material to help withstand the radial and rolling forces received by the wheels. In one example, the first and second roller wheels 428 and 429 are made of steel (e.g., 304 steel). The drive path for the chain element radial load bearing 406 within the inner bearing chain portion channel 70 and the outer bearing chain portion channel 72, as defined by the inner support rail 56, outer support rail 66, and portions of the inner and outer roller drive chain assemblies 52 and 62, is typically defined by steel. In that regard, using steel as the material for the first and second roller wheels 428 and 429 results in increased friction between the steel surfaces of the inner and outer bearing chain portion channels 70 and 72 and the wheels 428 and 429, such as compared to plastic wheels rolling on steel surfaces.

Such increased frictional interface supports rolling of the first and second roller wheels 428 and 429 rather than sliding. Rolling is advantageous as it prevents undue wear on the first and second roller wheels 428 and 429 that would occur if they were to slide. Sliding leads to excess shear force acting on the wheels 428 and 429, which results in greater wear.

Additionally, using steel for the first and second roller wheels 428 and 429 decreases the likelihood of crack propagation in the wheels due to its material properties. Plastic wheels, as used with prior art designs, are typically manufactured via injection molding, which creates a weld line where the molds meet. Crack propagation or rolling fatigue can occur at the weld line, in addition to other areas of the plastic wheel. Using steel for the first and second roller wheels 428 and 429 substantially resolves the issue of crack propagation. Steel is better equipped to handle radial loads experienced by the chain element radial load bearing 406, which helps to decrease overall crack propagation and wear on the first and second roller wheels 428 and 429.

Using steel for the first and second roller wheels 428 and 429 helps support rolling of the wheels within the inner bearing chain portion channel 70 and helps withstand the radial and rolling forces received by the wheels, as discussed above. However, upper and lower surfaces of the chain element radial load bearing 406 often need to glide along curved portions of the inner bearing chain portion channel 70, like that shown for the bearing chain assembly 100 in FIG. 11. An upper, outer end of the first roller wheel 428 may engage the curved surface of the inner bearing chain portion channel 70 as the chain element radial load bearing 406 passes through the curved section of the inner bearing chain portion channel 70.

Prior art designs used plastic roller wheels to support such gliding. As can be appreciated, a plastic wheel would slide relatively easily along the steel surface of the inner bearing chain portion channel 70. By contrast, a steel wheel, such as the steel first or second roller wheel 428 or 429, would not slide easily as there is greater friction between steel components. In that regard, and as noted above, the chain element radial load bearing 406 includes a glide bearing assembly configured to facilitate sliding movement of the bearing chain assembly 400 along curved upper and lower surfaces of the return path.

The glide bearing assembly of the chain element radial load bearing 406 is generally defined by first and second glide bearings 424 and 426 secured to the outer surfaces of the first and second roller wheels 428 and 429. Thus, the first and second glide bearings 424 and 426 are located on the first and second roller wheels 428 and 429 such that they are between the first and second roller wheels 428 and 429 and any curved upper and lower surfaces of the return path during operation. In that regard, the first and second glide bearings 424 and 426 are configured to facilitate gliding of the chain element radial load bearing 406 along curved portions of the return path with minimal friction. It should be appreciated that the first and second glide bearings 424 and 426 are also configured to facilitate gliding of the chain element radial load bearing 406 along curved upper and lower surfaces of the drive path in applicable systems. Thus, reference to “return path” may be generally understood to include the drive path, and vice versa.

The first and second glide bearings 424 and 426 are substantially identical; and therefore, only the first glide bearing 424 will be described in detail. The first glide bearing 424 has a glide bearing body 433 that is generally cylindrical in shape and has a geometry configured to mate with the first roller wheel 428. In that regard, the glide bearing body 433 is sized and shaped to engage the substantially flat circular portion 470, the raised substantially flat circumferential portion 474, and the radial transition area (including the roller wheel tabs 472) of the first roller wheel 428. In the depicted example, the glide bearing body 433 has a diameter that is substantially equal to the combined diameter of the substantially flat circular portion 470 and the raised substantially flat circumferential portion 474 of the first roller wheel 428.

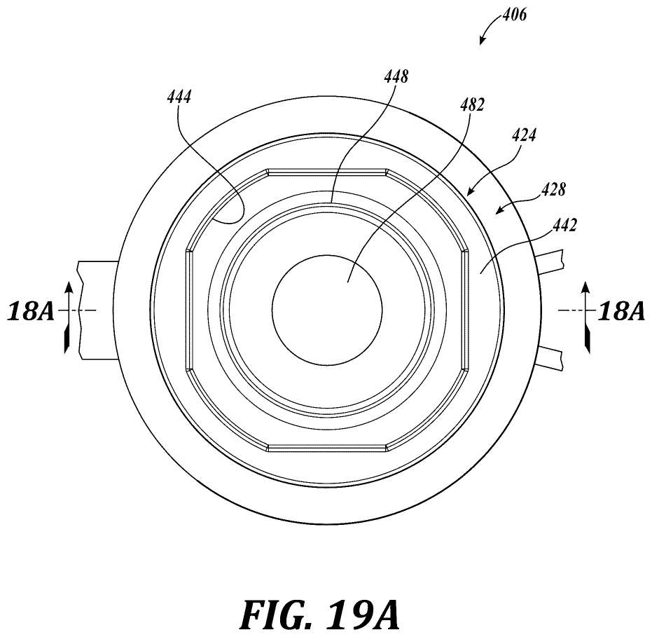

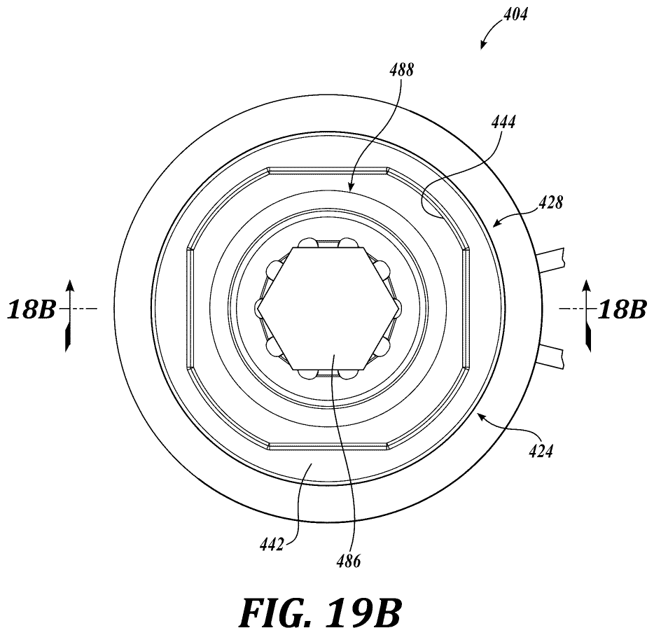

However, the diameter of the glide bearing body 433 is less than the overall diameter of the first roller wheel 428 so as to not interfere with rolling action of the first roller wheel 428. For instance, as can be seen in FIGS. 18A and 19A, the radial flange 478 of the first roller wheel 428 protrudes radially from the outer edge of the glide bearing body 433. This configuration also substantially avoids any stress concentration points and/or cyclic loading on the glide bearing during the rolling action of the bearing chain assembly 400.

For instance, as can be seen in the first glide bearing 424 shown in FIG. 16, the glide bearing body 433 includes a substantially flat, first circular bottom portion 441 surrounding the central opening 434. A raised, circumferential flattened glide portion 442 circumferentially surrounds the circular bottom portion 441. The raised, circumferential flattened glide portion 442 defines a glide bearing surface of the first glide bearing 424. Specifically, the raised, circumferential flattened glide portion 442 defines a substantially flat, horizontal outer circumferential surface that is configured to engage and glide along the curved surfaces of the return path with minimal friction (see FIG. 11 for reference).

The bottom planar surface 431 of the glide bearing body 433 extends radially along both the circular bottom portion 441 and the raised, circumferential flattened glide portion 442. The bottom planar surface 431 is substantially the same radial size as, and is configured to rest against the raised substantially flat circumferential portion 474 of the first roller wheel 428. Loads imposed on the raised circumferential flattened glide portion 442 of the first glide bearing 424 may be transferred to the chain element radial load bearing 406 through the raised substantially flat circumferential portion 474 of the first roller wheel 428.

The first glide bearing 424 is made from a suitable material to facilitate gliding while enduring frictional and radial loads imposed during the gliding movement. For instance, the first glide bearing 424 is made of a suitable plastic having a low frictional coefficient, thus supporting gliding rather than gripping. In some examples, the first glide bearing 424 is made of POM-C plastic, which can be less susceptible to cracks than other plastics such as PA12 nylon. For instance, POM-C can be made from processes and/or materials selected to absorb less water in 50% RH than PA12 nylon. Water absorbed into small impurities developed within the glide bearing can cause cracks when the temperature goes below freezing. Thus, POM-C plastic can be less susceptible to cracks than PA12 nylon or similar materials. Although POM-C may be more susceptible to wear than some plastics, such as PA12 nylon, the exposure to wearing forces is minimized in the present bearing chain assembly 400 by using steel wheels for rolling and a separate glide bearing for gliding. In any event, the material of the first glide bearing 424 is preferably suitable for the low temperatures of an industrial freezer (e.g., down to −40°C), but other materials may be used for other environments.

The first and second glide bearings 424 and 426 are secured to the first and second roller wheels 428 and 429, respectively, such that they rotate and move with the roller wheels through the drive and return paths. As noted above, the chain element radial load bearing 406 includes a connection assembly configured to secure the bearing components relative to one another, and a synchronous-motion assembly configured to substantially maintain alignment and synchronous movement of the bearing components during operation. Detailed exemplary aspects of the connection assembly and the synchronous-motion assembly will now be described.

In one aspect, the connection assembly and the synchronous-motion assembly include the through-shaft 436, referenced above, which extends centrally through the chain element radial load bearing 406. The through-shaft 436 is configured to extend through centrally aligned openings in the first and second roller wheels 428 and 429, the first and second glide bearings 424 and 426, and corresponding first and second glide bearing hold down washers 448 and 450.

In the depicted example, the through-shaft 436 includes a central cylindrical body 490 having a first diameter and first and second protruding cylindrical end portions 492 and 496 having a second diameter smaller than the first diameter of the central cylindrical body 490. The change in diameter from the central cylindrical body 490 to the first and second cylindrical protruding end portions 492 and 496 occurs at a substantially 90-degree angle, thereby defining a substantially flat contact surface 494 at each of the first and second ends of the central cylindrical body 190. The substantially flat contact surface 494 at each of the first and second ends of the central cylindrical body 490 is configured to engage and support the inner surface of the substantially flat circular portion 470 of each wheel 428 and 429, respectively.

The first and second cylindrical protruding end portions 492 and 496 of the through-shaft 436 are configured to protrude through the correspondingly aligned openings in the first and second roller wheels 428 and 429, the first and second glide bearings 424 and 426, and the first and second glide bearing hold down washers 448 and 450. More specifically, with the first and second glide bearings 424 and 426 secured within/to the first and second roller wheels 428 and 429 and with the first and second glide bearing hold down washers 448 and 450 secured within/to the first and second glide bearings 424 and 426, the first and second cylindrical protruding end portions 492 and 496 of the through-shaft 436 are configured to protrude through the aligned openings in each.

The second cylindrical protruding end 496 includes a head 480 having a diameter larger in size than the diameter of the aligned openings of the second roller wheel 429 and the second glide bearing hold down washer 450. In that regard, the interface of the head 480 and the second glide bearing hold down washer 450 prevents the through-shaft 436 from moving axially upwardly within the chain element radial load bearing 406. A tail 482 at the first cylindrical protruding end portion 492, opposite the head 480, is configured to pass through the aligned openings of the first roller wheel 428 and the first glide bearing hold down washer 448. Upon installation of the through-shaft 436 within aligned components of the chain element radial load bearing 406 (i.e., after the tail 482 is passed through the aligned openings of the first roller wheel 428 and the first glide bearing hold down washer 448), the tail is permanently deformed to secure the components of the chain element radial load bearing 406 in place relative to the through-shaft 436. As can be appreciated, the through-shaft 436 may be understood to define a roller rivet fastener for the chain element radial load bearing 406.

A suitable locking interface is defined between the through-shaft 436 and the first and second roller wheels 428 and 429 to rotationally constrain the components. In the depicted example, the first and second cylindrical protruding end portions 492 and 496 of the through-shaft 436 and the openings in the first and second roller wheels 428 and 429 are non-circular in cross-sectional shape. For instance, the first and second cylindrical protruding end portions 492 and 496 each include flattened, truncated opposing sides extending axially along the end portion. Central openings in the first and second roller wheels 428 and 429 are correspondingly shaped (e.g., the openings are circular with flattened opposing sides) to mate with the circular, truncated cross-sectional shape of the first and second cylindrical protruding end portions 492 and 496.

The openings in the first and second roller wheels 428 and 429 are also substantially the same cross-sectional size of the first and second cylindrical protruding end portions 492 and 496. In that regard, the first and second cylindrical protruding end portions 492 and 496 of the through-shaft 436 are configured to fit with little clearance into the openings in the first and second wheels 128 and 129. In this manner, when the wheels 428 and 429 rotate, the through-shaft 436 forces substantially synchronous motion of the first and second roller wheels 428 and 429 of the chain element radial load bearing 406. The cylindrical through-shaft 436 may be made from a suitable material to withstand forces imposed by the first and second roller wheels 428 and 429, such as steel.

The synchronous-motion assembly, including the connection assembly, rotationally constrains the first and second roller wheels 428 and 429 relative to the through-shaft 436. In that regard, the first and second roller wheels 428 and 429 rotate substantially in unison. In previous designs using plastic wheels, slippage occurred between the wheels, causing a rotation angle offset of the wheel pair. Also, as noted above, previous designs caused the first roller wheel to be urged upwardly and inwardly as radial forces were applied to the first roller wheel, separating the first roller wheel from the second roller wheel. Separation of the roller wheels caused the lateral ends of the spring clips to bend at a greater angle than they had been designed to bend. The wheel slippage and vertical separation resulted in fatigue stress and cyclic loading on the spring clip, leading to crack propagation, especially at the sharp edges of mating surfaces. Crack propagation weakens the spring clip and threatens the integrity of the bearing chain assembly. Such crack propagation and/or weakening of the spring clip may even occur in the radial load bearing 104 of the bearing chain assembly 100 in extended use applications.

The chain element radial load bearing 406 of the present disclosure has addressed this issue by eliminating the spring clip and incorporating a unique synchronous-motion assembly and connection assembly to rotationally constrain the first and second roller wheels 428 and 429 relative to the through-shaft 436. The first and second roller wheels 428 and 429 are forced to roll substantially synchronously and in axial alignment. Further, the wheel design of the chain element radial load bearing 406 substantially prevents vertical wheel separation. Rather, the outer surfaces of the radial flange 478 of both the first and second roller wheels 428 and 429 substantially stay engaged with the radial surfaces of the drive path during rolling. Substantially synchronous rolling results in radial loads acting concurrently on both the first and second wheels 428 and 429, further resulting in a symmetric load on the through-shaft 436. A symmetric load prevents the bearing chain assembly 400 from twisting and reduces cyclic loading on the components of the chain element radial load bearing 406.

The synchronous-motion assembly is also configured to rotationally constrain the first and second glide bearings 424 and 426 relative to the first and second roller wheels 428 and 429. In a first aspect, and with reference to the interaction of the first glide bearing 424 and first roller wheel 428, the glide bearing body 433 of the first glide bearing 424 is configured to lockingly engage with the first roller wheel 428. In the example depicted, the glide bearing body 433 has a bottom geometry that enables the glide bearing body 433 to be positively locked in substantially the center of the first roller wheel 428. For instance, as can be seen in the second glide bearing 426 shown in FIG. 16, the glide bearing body 433 includes a plurality of glide bearing tabs 440 defined on a bottom planar surface 431 of the glide bearing body 433 and surrounding a central opening 434 of the first glide bearing 424. Each of the plurality of glide bearing tabs 440 are configured to engage the radial transition area of the first roller wheel 428 in between adjacent roller wheel tabs 472. In that regard, each of the plurality of glide bearing tabs 440 has a shape that is substantially opposite the shape of the radial transition area of the first roller wheel 428 in between adjacent roller wheel tabs 472. A circumferential gap is defined between adjacent glide bearing tabs 440 that is sized to receive a roller wheel tab 472. The interface of the plurality of glide bearing tabs 440 and roller wheel tabs 472 define part of the synchronous-motion assembly in that they substantially lockingly engage the first glide bearing 424 with the first roller wheel 428 to facilitate substantially synchronized motion between the first glide bearing and the first roller wheel.

In another aspect, the glide bearing body 433 also has a top geometry that helps facilitate rotational constraint of the first glide bearing 424 relative to the first roller wheel 428. In the depicted example, the top geometry of the glide bearing body 433 non-rotationally interfaces with a first glide bearing hold down washer 448 configured to receive a pressing force of the tail 482 of the through-shaft 436.

In the depicted example, the glide bearing body 433 includes a circumferential wall 444 that extends substantially transversely between the circular bottom portion 441 and the raised, circumferential flattened glide portion 442. The circumferential wall 444 is configured to define a receptacle within the top of the first glide bearing 424 having a cross-sectional shape for non-rotationally receiving the first glide bearing hold down washer 448. In the example depicted, the circumferential wall 444 is segmented into multiple sections to define an overall non-circular cross-sectional wall shape. For instance, the substantially transverse circumferential wall 444 may include eight sections to create an octagonally-shaped receptable for non-rotationally receiving a correspondingly shaped first glide bearing hold down washer 448. Of course, other shapes are possible.

The first and second glide bearing hold down washers 448 and 450, when non-rotationally received within the first and second glide bearings 424 and 426, are generally configured to axially secure the first and second glide bearings 424 and 426 to the first and second roller wheels 428 and 429 through the pressing force of the head 480 and tail 482 of the through-shaft 436. The first and second glide bearing hold down washers 448 and 450 are identical, and therefore, only the first glide bearing hold down washer 448 will be described in detail.

The first glide bearing hold down washer 448 has a substantially planar body that is shaped to generally correspond to the overall combined shape of the substantially flat circular portion 470 of the first roller wheel 428 and the circular bottom portion 441 of the first glide bearing 424 when the first glide bearing 424 is mated against the first roller wheel 428. Moreover, central opening of the first glide bearing hold down washer 448 is substantially aligned with and is generally the same overall circular size as the central opening in the first roller wheel 428 and the first cylindrical protruding end portion 492 of the through-shaft 436. In that regard, the tail 482 of the through-shaft 436 may impose a pressing force against the first glide bearing hold down washer 448. In effect, the first glide bearing hold down washer 448 imposes a pressing force against both the substantially flat circular portion 470 of the first roller wheel 428 and the circular bottom portion 441 of the first glide bearing 424. An opposing pressing force is imposed by the head 480 of the through-shaft 436 against the second glide bearing hold down washer 450. In effect, the second glide bearing hold down washer 450 imposes a pressing force against both the substantially flat circular portion 470 of the second roller wheel 429 and the circular bottom portion 441 of the second glide bearing 426. The opposing pressing forces imposed by the head 480 and tail 482 of the through-shaft 436 lock the components of the chain element radial load bearing 406 in place.

Detailed exemplary aspects of the chain connection radial load bearing 404 of the bearing chain assembly 400 will now be described with reference to FIGS. 15-17, 18B and 19B. The chain connection radial load bearing 404 is substantially similar to the chain element radial load bearing 406 in that it generally includes a roller assembly configured to facilitate rolling of the bearing chain assembly 400 along radial surfaces of the drive path, a glide bearing assembly configured to facilitate sliding movement of the bearing chain assembly 400 along curved upper and lower surfaces of the return path, a connection assembly configured to secure the roller and bearing components relative to one another, and a synchronous-motion assembly configured to substantially maintain alignment and synchronous movement of the roller components during operation.

However, the chain connection radial load bearing 404 is also configured for connecting opposite ends of the bearing chain assembly 400 to assemble the bearing chain assembly 400 as a continuous endless loop. In that regard, the chain connection radial load bearing 404 differs from the chain element radial load bearing 406 in that the connection assembly and synchronous-motion assembly also facilitate disassembly of the roller and bearing components. With the chain connection radial load bearing 404 disassembled, a first end of the bearing chain assembly 400 can be connected to a second end of the bearing chain assembly 400 by securing the relevant portion of the linkage assembly between end horizontal and vertical load bearings. As discussed above, the linkage assembly is configured to hold neighboring horizontal and vertical load bearing assemblies 404/406 and 108 in a spaced relationship relative to each other.

The chain element radial load bearing 406 is identical to the chain connection radial load bearing 404 except for the differences in the connection assembly and synchronous-motion assembly, which are configured to support disassembly of the roller and bearing components. Thus, only aspects of the 404 that differ from the chain element radial load bearing 406 will be hereinafter described in detail. Moreover, identical parts use identical reference numbers for ease of reference.

Like the chain connection radial load bearing 404, the chain element radial load bearing 406 includes the first and second roller wheels 428 and 429, the first and second glide bearings 424 and 426, the first and second glide bearing hold down washers 448 and 450, and a through-shaft that extends axially through the components. However, the chain connection radial load bearing 404 includes a modified through-shaft 437 to facilitate disassembly of the chain connection radial load bearing 404.

Like the through-shaft 436, the modified through-shaft 437 of the chain connection radial load bearing 404 is configured to impose a pressing force at the second protruding end 497 when inserted through the axially aligned openings in the chain connection radial load bearing 404. In that regard, the modified through-shaft 437 includes a head 481 at the second protruding end 497 that engages and imposes a pressing force against the second glide bearing hold down washer 450 (and therefore the second glide bearing 426 and the second roller wheel 429) when the hold down washer is mated with the second glide bearing 426 and the second roller wheel 429. However, at an opposite, first protruding end 493 of the modified through-shaft 437, the modified through-shaft 437 is configured to selectively impose a pressing force on the first glide bearing hold down washer 448 (and therefore the first glide bearing 424 and the first roller wheel 428) with a removable, rather than a permanent, fastener to facilitate disassembly of the chain connection radial load bearing 404.

In the depicted example, a threaded, axial receptacle 484 extends from an outer surface of the first protruding end 493 into a central cylindrical body 491 of the modified through-shaft 437. The threaded, axial receptacle 484 is configured to threadably receive a fastener 486, such as a hex screw, a bolt, etc., therein. A head of the fastener 486 is configured to impose a pressing force on the first glide bearing hold down washer 448. The opposing pressing forces imposed by the head 480 of the through-shaft 437 and the fastener 486 lock the components of the chain connection radial load bearing 404 in place.

At least one washer may be disposed between the head of the fastener 486 and the first glide bearing hold down washer 448 to help distribute the pressing load of the fastener 486 and to help retain threaded engagement of the fastener 486 with the axial receptacle 484. In the depicted example, an internal tooth lock washer 488 is located above the first glide bearing hold down washer 448, and a flat washer 489 is disposed between the teeth of the internal tooth lock washer 488 and the bottom surface of the fastener head. The pressing force of the fastener 486 passes through the flat washer 489, the internal tooth lock washer 488, and down into the first glide bearing 424 and the first roller wheel 428.

The internal tooth lock washer 488 may have an overall shape configured to be non-rotationally received within the first glide bearing hold down washer 448. In that regard, the internal tooth lock washer 488 has a substantially planar body that is shaped to generally correspond to the overall combined shape of the substantially flat circular portion 470 of the first roller wheel 428 and the circular bottom portion 441 of the first glide bearing 424 when the first glide bearing 424 is mated against the first roller wheel 428. In this manner, the internal tooth lock washer 488, flat washer 489, and fastener 486 rotate synchronously with the first glide bearing 424 and the first roller wheel 428. Accordingly, the interface between the internal tooth lock washer 488 and the first glide bearing hold down washer 448 may be understood to define a portion of the synchronous-motion assembly.

As can be appreciated, the modified through-shaft 437, fastener 486, internal tooth lock washer 488, and flat washer 489 collectively provide connection assembly and synchronous-motion assembly capabilities a while facilitating disassembly of the chain connection radial load bearing 404. When a chain connection radial load bearing 404 at a first end of the bearing chain assembly 400 is disassembled, the chain connection radial load bearing 404 can be connected to a vertical load bearing 108 at the second end of the bearing chain assembly 400 via the linkage.

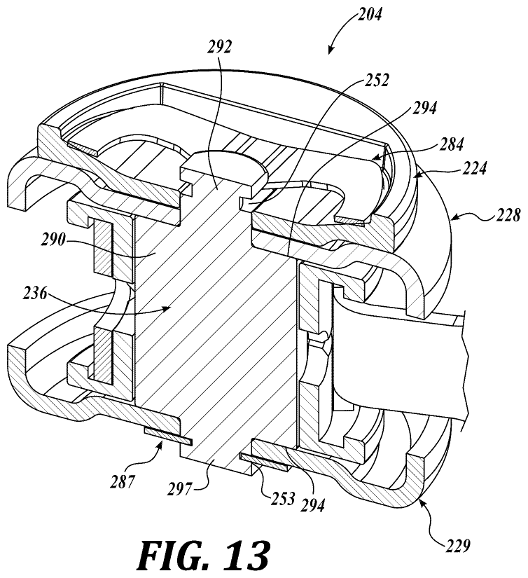

It should be appreciated that both the chain connection radial load bearing 404 and the chain element radial load bearing 406 may instead be configured to include only a single glide bearing like the radial load bearing 204 described above with reference to FIGS. 12 and 13. For instance, the chain connection radial load bearing 404 and the chain element radial load bearing 406 may include only one glide bearing, e.g., the second glide bearing 426 may be excluded. In such an example, the second glide bearing hold down washer 450 may be adapted to mate directly with the second roller wheel 429 and the second cylindrical protruding end portion 496 of the through-shaft 436.

An alternative example of a bearing chain assembly 500 for use as the inner bearing chain portion 59 and the outer bearing chain portion 69 will now be described with reference to FIGS. 20-24. The bearing chain assembly 500 is substantially identical to the bearing chain assembly 400 except that it includes radial load bearings that differ from the radial load bearings 404 and 406. More specifically, the bearing chain assembly 500 includes a chain connection radial load bearing 504 and a chain connection radial load bearing 506. Like the bearing chain assembly 400, the radial load bearings 504 and 506 of the bearing chain assembly 500 are alternately arranged with vertical load bearings 108. The vertical load bearings 108 of the bearing chain assembly 500 are identical to the vertical load bearings 108 of the bearing chain assembly 100. Thus, only the radial load bearings 504 and 506 of the bearing chain assembly 500 will be described in detail.

Generally, the chain connection radial load bearing 504 is configured for connecting opposite ends of the bearing chain assembly 500 to configure the bearing chain assembly 400 as a continuous endless loop, and the chain connection radial load bearing 506 is configured for defining a radial load chain element of the bearing chain assembly 500. In that regard, the bearing chain assembly 500 may include only a single (or few) chain connection radial load bearing 504 for defining the bearing chain assembly 500 as a continuous endless loop, and most of the radial load bearings of the bearing chain assembly 500 may be defined as chain connection radial load bearings 506.

Both the chain connection radial load bearing 504 and the chain element radial load bearing 506 are configured to support radial loads when the drive assembly 26 is driving the spiral stack while supporting gliding movement of the bearing chain assembly 500 along curved surfaces of the drive assembly 26 that cannot be supported by the vertical load bearings 108, like the radial load bearing 104. The bearing chain assembly 500 experiences radial forces from the wrapping of the drive chain assembly 26 and the wrapping and tension imposed by the conveyor belt 34, as discussed above for the bearing chain assembly 100. The radial load bearings 504 and 506 are configured to support such radial loads and facilitate gliding movement of the bearing chain assembly 500 along the drive and return path, all while minimizing component wear and failure. In fact, in some applications, the bearing chain assembly 500 may better withstand cyclic loads when compared to the bearing chain assemblies 100 and 400.

Detailed exemplary aspects of the chain connection radial load bearing 504 will now be described with reference to FIGS. 20-22, 23A and 24A. The chain connection radial load bearing 504 generally includes a roller assembly configured to facilitate rolling of the bearing chain assembly 500 along radial surfaces of the drive path, a glide bearing assembly configured to facilitate sliding movement of the bearing chain assembly 500 along curved upper and lower surfaces of the return path, a connection assembly configured to secure the roller and bearing components relative to one another, and a synchronous-motion assembly configured to substantially maintain alignment and synchronous movement of the roller components during operation.

The roller assembly, which is configured to facilitate rolling of the bearing chain assembly 500 along radial surfaces of the drive path, will first be described. The roller assembly includes a first roller wheel 528 positioned opposite and substantially mirrored in configuration relative to a second roller wheel 529. The first and second roller wheels 528 and 529 are secured together and are spaced apart through a wheel interface assembly 537 defined between interior facing portions of the first and second roller wheels 528 and 529. The wheel interface assembly 537 facilitates substantially synchronous rotation of the wheels about a radial load roller bearing wheel rotation axis 538. In that regard, the wheel interface assembly 537 forms part of the synchronous-motion assembly configured to substantially maintain alignment and synchronous movement of the roller components during operation. The wheel interface assembly 537 also forms part of the connection assembly configured to secure the roller and bearing components relative to one another.

Detailed exemplary aspects of the first and second roller wheels 528 and 529 will now be provided. The first roller wheel 528 includes a first roller wheel portion 575 and the second roller wheel 529 includes a second roller wheel portion 579 that is substantially identical to the first roller wheel portion 575. The first and second roller wheel portions 575 and 579 are generally cylindrical in shape to facilitate rolling of the first and second roller wheels 528 and 529. In that regard, the outer surfaces of the first and second roller wheel portions 575 and 579 define flat rolling surfaces substantially parallel to the rotation axis of the first and second roller wheels 528 and 529, respectively. The outer flat rolling surfaces of the first and second roller wheel portions 575 and 579 are configured to receive radial loads experienced by the chain connection radial load bearing 504 and facilitate rolling of the wheels along radial surfaces of the drive path.

The outer flat rolling surfaces defined by the first and second roller wheel portions 575 and 579 of the first and second wheels 528 and 529 define, in part, the synchronous-motion assembly of the bearing chain assembly 500 configured to substantially maintain alignment and synchronous movement of the bearing chain assembly roller components within the inner bearing chain portion channel 70. The outer flat rolling surfaces defined by the first and second roller wheel portions 575 and 579 interface with an inner surface of the radially outer vertical wall 78 of the inner support rail 56 and the downwardly extending flanges 97 of the inner bearing chain assembly 52. The substantially flat interface between the first and second roller wheel portions 575 and 579 and the corresponding surfaces of the inner bearing chain portion channel 70 help maintain alignment of the first and second wheels 528 and 529 with the rotation axis of the chain element radial load bearing 506. Moreover, as will be discussed further below, the wheel interface assembly 537 of the connection assembly helps secure the first roller wheel 528 relative to the second roller wheel 529 to facilitate substantially synchronous rotation of the wheels about a radial load roller bearing wheel rotation axis 538. Thus, the wheel interface assembly 537 also defines part of the synchronous-motion assembly for the bearing chain assembly 500.

The synchronous-motion assembly helps maintain contact between the substantially flat rolling surfaces of the first and second roller wheel portions 575 and 579 and the corresponding surfaces of the inner bearing chain portion channel 70. As discussed above, previous roller wheel designs often resulted in a radial load bearing tilting in certain sections of the drive path. Specifically, an edge of the wheel would engage a curved transition portion between the upper horizontally planar pitch 90 and the downwardly extending flange 97 of the inner bearing chain assembly 52. As radial forces were applied to the first roller wheel by the downwardly extending flange 97, the first roller wheel would be urged upwardly and radially inwardly. Such movement of the first roller wheel would tilt the entire bearing chain assembly about an axis transverse to the rotation axis of the radial load bearing and was likely a source of high cycle fatigue due to the increased radial loads on the second roller wheel.

In the bearing chain assembly 500 described herein, the geometry of the first and second roller wheels 528 and 529 of the chain element radial load bearing 506 are configured to substantially maintain contact between the substantially flat rolling surfaces of the first and second roller wheel portions 575 and 579 and the corresponding surfaces of the inner bearing chain portion channel 70 (e.g., the downwardly extending flange 97). As such, the bearing chain assembly 500 does not tilt as in the prior art design, and radial loads are distributed substantially evenly across both the first and second roller wheels 528 and 529 of the chain element radial load bearing 506.

The first and second roller wheels 528 and 529 are also made of a suitable material to help withstand the radial and rolling forces received by the wheels. In one example, the first and second roller wheels 528 and 529 are made of steel. The drive path for the chain element radial load bearing 406 within the inner bearing chain portion channel 70 and the outer bearing chain portion channel 72, as defined by the inner support rail 56, outer support rail 66, and portions of the inner and outer roller drive chain assemblies 52 and 62, is typically defined by steel. In that regard, using steel as the material for the first and second roller wheels 528 and 529 results in increased friction between the steel surfaces of the inner and outer bearing chain portion channels 70 and 72 and the wheels 528 and 529, such as compared to plastic wheels rolling on steel surfaces.

Such increased frictional interface supports rolling of the first and second roller wheels 528 and 529 rather than sliding. Rolling is advantageous as it prevents undue wear on the first and second roller wheels 528 and 529 that would occur if they were to slide. Sliding leads to excess shear force acting on the wheels 528 and 529, which results in greater wear.

Additionally, using steel for the first and second roller wheels 528 and 529 decreases the likelihood of crack propagation in the wheels due to its material properties. Plastic wheels, as used with prior art designs, are typically manufactured via injection molding, which creates a weld line where the molds meet. Crack propagation or rolling fatigue can occur at the weld line, in addition to other areas of the plastic wheel. Using steel for the first and second roller wheels 528 and 529 substantially resolves the issue of crack propagation. Steel is better equipped to handle radial loads experienced by the chain element radial load bearing 506, which helps to decrease overall crack propagation and wear on the first and second roller wheels 528 and 529.

As noted above, the first and second roller wheels 528 and 529 are secured together and are spaced apart through the wheel interface assembly 537 defined between interior facing portions of the first and second roller wheels 528 and 529. The wheel interface assembly 537 is used in part to secure the roller and bearing components relative to one another and used in part to substantially maintain alignment and synchronous rotation of the wheels about the radial load roller bearing wheel rotation axis 538. In the depicted example, the wheel interface assembly 537 is defined by the interaction of a female hub portion 536 extending inwardly from the first roller wheel portion 575 and a male hub portion 539 extending inwardly from the second roller wheel portion 579. The male hub portion 539 of the second roller wheel 529 is configured to lockingly mate with the female hub portion 536 of the first roller wheel 528 to substantially prevent inward axial movement of the first and second roller wheels 528 and 529 relative to one another while also helping to prevent rotational movement of the first and second roller wheels 528 and 529 relative to one another.

In the depicted example, the male hub portion 539 is generally defined by a first cylindrical hub portion 541 extending from an interior surface of the second roller wheel portion 579 and having a first outer diameter. A second cylindrical hub portion 543 extends from an interior surface of the first cylindrical hub portion 541 and has a second outer diameter smaller than the first outer diameter. The first cylindrical hub portion 541 includes a first male cylindrical hub section 545 having a first axial length and a second male cylindrical hub section 547 having a second axial length shorter than the first axial length. Generally, the first male cylindrical hub section 545 is defined on a first half of the first cylindrical hub portion 541 and the second male cylindrical hub section 547 is defined on a second half of the first cylindrical hub portion 541 (when viewing the cross-section of the first cylindrical hub portion 541).

A locking shoulder extends between the first cylindrical hub portion 541 and the second cylindrical hub portion 543. The locking shoulder is defined by one or more surfaces extending generally transversely between the first cylindrical hub portion 541 and the second cylindrical hub portion 543. In the depicted example, the locking shoulder is defined by a first substantially transverse locking shoulder surface 549 extending between the first male cylindrical hub section 545 of the first cylindrical hub portion 541 and the outer cylindrical surface of the second cylindrical hub portion 543, a second substantially transverse locking shoulder surface 553 extending between the second male cylindrical hub section 547 of the first cylindrical hub portion 541 and the outer cylindrical surface of the second cylindrical hub portion 543, and a substantially axially aligned transverse locking shoulder surface 555 extending between the first substantially transverse locking shoulder surface 551 and the second substantially transverse locking shoulder surface 553.

The female hub portion 536 is generally defined by a hollow cylindrical hub portion 557 extending from an interior surface of the first roller wheel portion 575. The hollow cylindrical hub portion 557 generally has the inverse shape of the male hub portion 539 such that when mated, the female hub portion 536 and the male hub portion 539 together define a substantially cylindrical hub extending between the first and second wheel portions 575 and 579.

The cylindrical hub portion 557 includes a first female cylindrical hub section 561 having a first axial length and a second female cylindrical hub section 563 having a second axial length longer than the first axial length. Generally, the first female cylindrical hub section 561 is defined on a first half of the hollow cylindrical hub portion 557 and the second female cylindrical hub section 563 is defined on a second half of the hollow cylindrical hub portion 557 (when viewing the cross-section of the hollow cylindrical hub portion 557). The longer second female cylindrical hub section 563 is configured to mate up against the shorter second male cylindrical hub section 547 and the shorter first female cylindrical hub section 561 is configured to mate up against the longer first male cylindrical hub section 545. In that regard, a keyed locking interface is defined between the female hub portion 536 and the male hub portion 539. More specifically, corresponding opposing locking shoulder surfaces of the male hub portion 539 and the female hub portion 536 engage one another and substantially prevent axial and rotational movement of the first and second roller wheels 528 and 529 relative to one another.

To ensure that the male and female hub portions 539 and 536 remain fixed relative to the roller wheel portions 579 and 575 of the first and second roller wheels 528 and 529, the male hub portion 539 is fixedly secured to the second roller wheel portion 579 and the female hub portion 536 is fixedly secured to the first roller wheel portion 575. In some examples, the second roller wheel 529 is cast of a suitable material (e.g., stainless steel) such that the male hub portion 539 is integrally formed with the second roller wheel portion 579. Moreover, the first roller wheel 528 is cast of a suitable material (e.g., stainless steel) such that the female hub portion 536 is integrally formed with the first roller wheel portion 575. Of course, the first and second roller wheels 528 may instead be integrally formed in any other suitable manner.

The hollow cylindrical hub portion 557 of the female hub portion 536 has an outer diameter that is substantially the same as the first outer diameter of the first male cylindrical hub section 545 of the male hub portion 539. A hub through-hole 559 extends axially along the hollow cylindrical hub portion 557 of the female hub portion 536 and has an inner diameter that is substantially the same as the second outer diameter of the second cylindrical hub portion 543 of the male hub portion 539. The second cylindrical hub portion 543 of the male hub portion 539 is receivable within the hub through-hole 559 of the female hub portion 536 such that the outer surfaces of the first male cylindrical hub section 545 of the male hub portion 539 and the hollow cylindrical hub portion 557 of the female hub portion 536 are substantially flush.

The female hub portion 536 and the male hub portion 539, when mated together to define a cylindrical hub extending between the first and second roller wheel portions 575 and 579, may be secured to the vertically oriented linkages 140 in a manner similar to how the vertical load bearing 108 is secured to the horizontally oriented linkages 144. For instance, first and second plastic inserts 132 and 134, identical to those described for the bearing chain assembly 100, house the cylindrical hub and moveably secure the cylindrical hub within the cylindrical tube 131 of the linkage. Specifically, the first and second plastic inserts 132 and 134 provide a bearing interface between the cylindrical hub and the cylindrical tube 131.

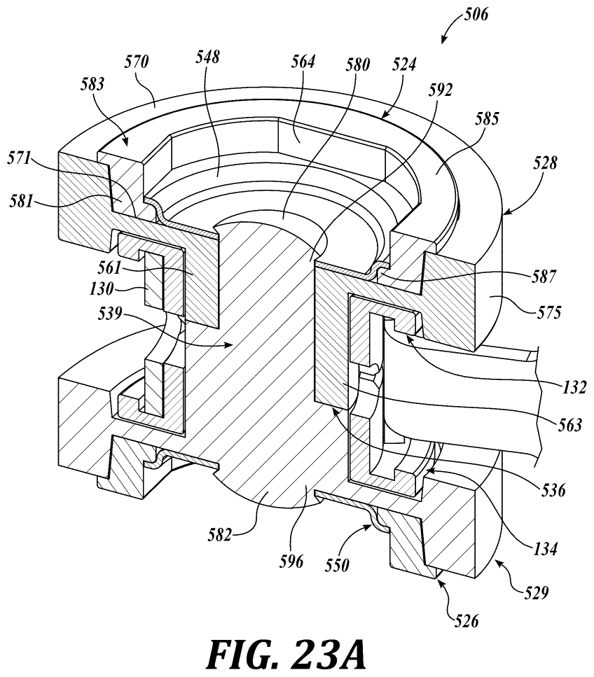

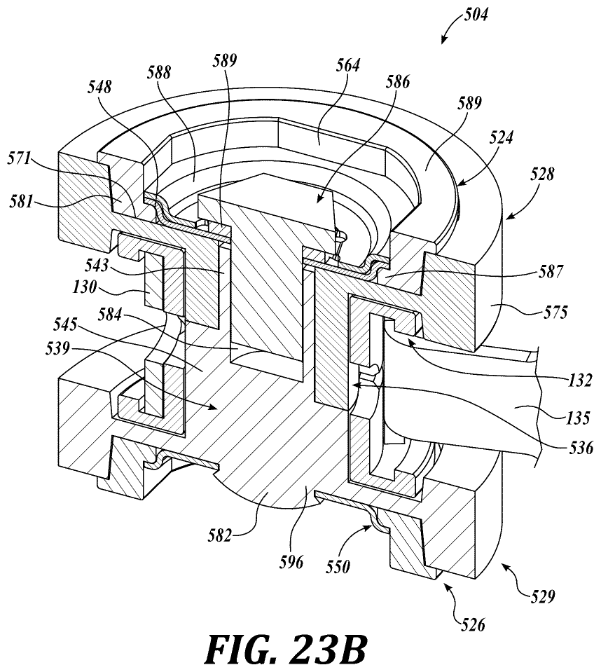

As seen in FIG. 23A, the first and second plastic inserts 132 and 134 include flanged ends that interface with the interior surfaces of the first and second roller wheels 528 and 529, respectively. The interior surface of the first roller wheel portion 575 from which the female hub portion 536 extends is substantially flat and recessed within the first roller wheel portion 575. The flanged end of the first plastic insert 132 is receivable within the interior recess of the first roller wheel portion 575. Similarly, the interior surface of the second roller wheel portion 579 from which the male hub portion 539 extends is substantially flat and recessed within the second roller wheel portion 579. The flanged end of the second plastic insert 134 is receivable within the interior recess of the second roller wheel portion 579.

As noted above, the first and second roller wheels 528 and 529 may be made from a suitable material, such as stainless steel, to facilitate rolling, durability, and cast formation. Using steel for the first and second roller wheels 528 and 529 helps support rolling of the wheels within the inner bearing chain portion channel 70 and helps withstand the radial and rolling forces received by the wheels, as discussed above. However, upper and lower surfaces of the chain element radial load bearing 506 often need to glide along curved portions of the inner bearing chain portion channel 70, like that shown for the bearing chain assembly 100 in FIG. 11. An upper, outer end of the first roller wheel 528 may engage the curved surface of the inner bearing chain portion channel 70 as the chain element radial load bearing 506 passes through the curved section of the inner bearing chain portion channel 70.

Prior art designs used plastic roller wheels to support such gliding. As can be appreciated, a plastic wheel would slide relatively easily along the steel surface of the inner bearing chain portion channel 70. By contrast, a steel wheel, such as the steel first or second roller wheel 528 or 529, would not slide easily as there is greater friction between steel components. In that regard, and as noted above, the chain element radial load bearing 506 includes a glide bearing assembly configured to facilitate sliding movement of the bearing chain assembly 500 along curved upper and lower surfaces of the return path.

The glide bearing assembly of the chain element radial load bearing 506 is generally defined by first and second glide bearings 524 and 526 secured to the outer surfaces of the first and second roller wheels 528 and 529. Thus, the first and second glide bearings 524 and 526 are located on the first and second roller wheels 528 and 529 such that they are between the first and second roller wheels 528 and 529 and any curved upper and lower surfaces of the return path during operation. In that regard, the first and second glide bearings 524 and 526 are configured to facilitate gliding of the chain element radial load bearing 506 along curved portions of the return path with minimal friction. It should be appreciated that the first and second glide bearings 524 and 526 are also configured to facilitate gliding of the chain element radial load bearing 506 along curved upper and lower surfaces of the drive path in applicable systems. Thus, reference to “return path” may be generally understood to include the drive path, and vice versa.

The first and second glide bearings 524 and 526 are substantially identical; and therefore, only the first glide bearing 524 will be described in detail. The first glide bearing 524 has a glide bearing body 533 that is generally cylindrical in shape and has a geometry configured to mate with an exterior of the first roller wheel 528. The first roller wheel 528 includes an exterior glide bearing recess 534 defined within a substantially flat exterior surface 570 of the first roller wheel portion 575. A substantially transverse circumferential wall 544 extends substantially transversely between the substantially flat exterior surface 570 to a substantially flat circular bottom portion 571 in the exterior glide bearing recess 534. The circumferential wall 544 has a cross-sectional shape for non-rotationally receiving a portion of the glide bearing body 533. In the example depicted, the circumferential wall 544 is segmented into multiple sections to define an overall non-circular cross-sectional wall shape. For instance, the circumferential wall 544 may include eight sections to create an octagonally-shaped receptable for non-rotationally receiving a correspondingly shaped portion of the glide bearing body 533. Of course, other shapes are possible.

The glide bearing body 533 is correspondingly sized and shaped to lockingly engage the exterior glide bearing recess 534. In the depicted example, the glide bearing body 533 has a first annular portion 581 that is generally sized and shaped to lockingly fit within the exterior glide bearing recess 534. For instance, the first annular portion 581 may have generally the same outer diameter as the inner diameter of the exterior glide bearing recess 534 and include eight exterior sections to define an overall octagonally-shaped first annular portion 581. The first annular portion 581 may extend axially from the substantially flat circular bottom portion 571 of the exterior glide bearing recess 534 past the substantially flat exterior surface 570 of the first roller wheel portion 575 when the glide bearing body 533 is received in the exterior glide bearing recess 534.

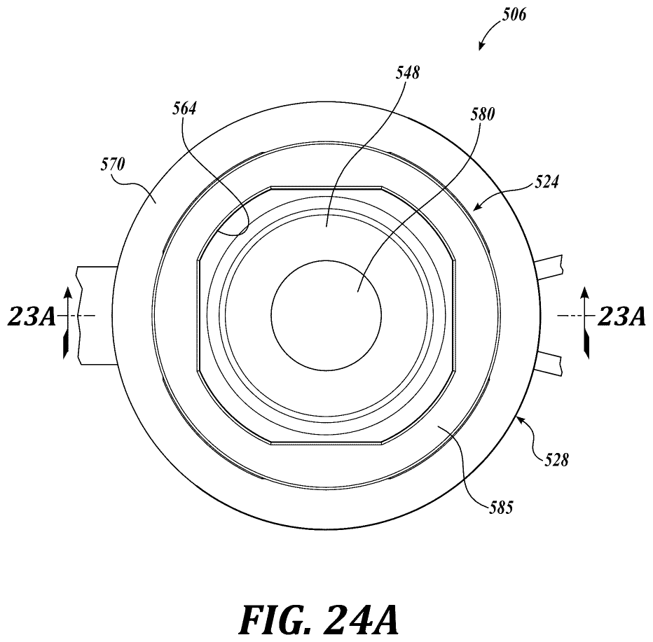

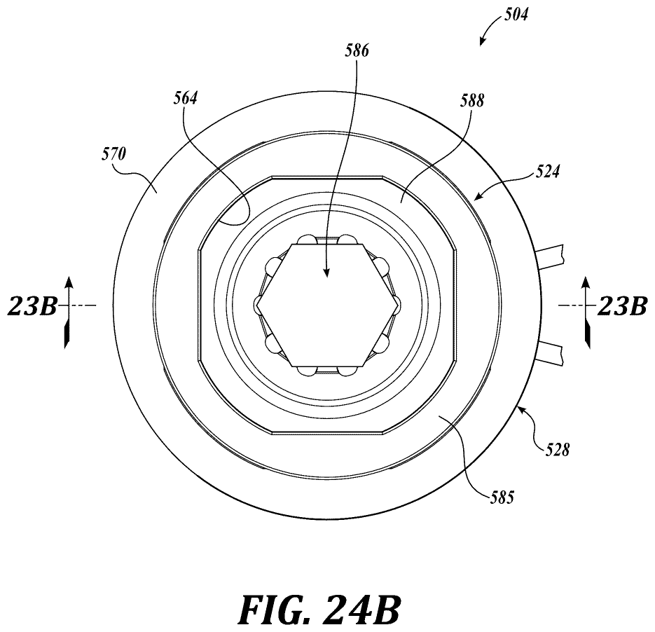

A first transverse annular lip 583 extends radially outwardly from an exterior axial end of the first annular portion 581 along the substantially flat exterior surface 570 of the first roller wheel portion 575. However, the transverse annular lip 583 terminates radially before the edge of the first roller wheel portion 575. In other words, the overall diameter of the glide bearing body 533 is less than the overall diameter of the first roller wheel 228 so as to avoid interference with rolling action of the first roller wheel 528. For instance, as can be seen in FIGS. 23A and 24A, the first roller wheel portion 575 of the first roller wheel 528 protrudes radially from the outer edge of the glide bearing body 533.

The first annular portion 581 and the transverse annular lip 583 define an exterior glide bearing surface 585 of the first glide bearing 524. The glide bearing surface 585 of the first glide bearing 524 is configured to engage and glide along the curved surfaces of the return path with minimal friction (see FIG. 11 for reference). This configuration substantially avoids any stress concentration points and/or cyclic loading on the glide bearing during the rolling action of the bearing chain assembly 500. Loads imposed on the first annular portion 581 and the transverse annular lip 583 of the first glide bearing 524 may be transferred to the chain element radial load bearing 506 through the first roller wheel portion 575 and the substantially flat circular bottom portion 571 of the first roller wheel 428.

A second transverse annular lip 587 extends radially inwardly from an interior axial end of the first annular portion 581 along the substantially flat circular bottom portion 571 of the exterior glide bearing recess 534. The second transverse annular lip 587 is generally sized to receive a lip of a first glide bearing hold down washer 548 for securing the first glide bearing 524 against the first roller wheel 528.

The first glide bearing 524 is made from a suitable material to facilitate gliding while enduring frictional and radial loads imposed during the gliding movement. For instance, the first glide bearing 524 is made of a suitable plastic having a low frictional coefficient, thus supporting gliding rather than gripping. In some examples, the first glide bearing 424 is made of POM-C plastic, which can be less susceptible to cracks than other plastics such as PA12 nylon. For instance, POM-C can be made from processes and/or materials selected to absorb less water in 50% RH than PA12 nylon. Water absorbed into small impurities developed within the glide bearing can cause cracks when the temperature goes below freezing. Thus, POM-C plastic can be less susceptible to cracks than PA12 nylon or similar materials. Although POM-C may be more susceptible to wear than some plastics, such as PA12 nylon, the exposure to wearing forces is minimized in the present bearing chain assembly 500 by using steel wheels for rolling and a separate glide bearing for gliding. In any event, the material of the first glide bearing 524 is preferably suitable for the low temperatures of an industrial freezer (e.g., down to −40°C), but other materials may be used for other environments.

The first and second glide bearings 524 and 526 are secured to the first and second roller wheels 528 and 529, respectively, such that they rotate and move with the roller wheels through the drive and return paths. As noted above, the chain element radial load bearing 506 includes a connection assembly configured to secure the bearing components relative to one another, and a synchronous-motion assembly configured to substantially maintain alignment and synchronous movement of the bearing components during operation. Further exemplary aspects of the connection assembly and the synchronous-motion assembly will now be described.

In one aspect, the connection assembly and the synchronous-motion assembly include the wheel interface assembly 537, which includes the cylindrical hub defined by the mated female hub portion 536 and male hub portion 539, discussed above. The cylindrical hub is configured to extend centrally through the chain element radial load bearing 506. Specifically, the cylindrical hub extends through centrally aligned openings in the first and second roller wheels 528 and 529, the first and second glide bearings 524 and 526, and corresponding first and second glide bearing hold down washers 548 and 550.

In the depicted example, the male hub portion 539 includes opposing first and second cylindrical protruding end portions 592 and 596 configured to protrude through the correspondingly aligned openings in the first and second roller wheels 528 and 529, the first and second glide bearings 524 and 526, and the first and second glide bearing hold down washers 548 and 550. More specifically, with the first and second glide bearings 524 and 526 secured within/to the first and second roller wheels 528 and 529 and with the first and second glide bearing hold down washers 548 and 550 secured within/to the first and second glide bearings 524 and 526, the first and second cylindrical protruding end portions 592 and 596 of the male hub portion 539 are configured to protrude through the aligned openings in each.

The first cylindrical protruding end portion 592 includes a first tail 580 configured to pass through the aligned openings of the first roller wheel 528 and the first glide bearing hold down washer 548. The second cylindrical protruding end 596 includes a second tail 582 configured to pass through the aligned openings of the second roller wheel 529 and the second glide bearing hold down washer 550. Upon installation of the male hub portion 539 within aligned components of the chain element radial load bearing 506 (i.e., after the tails 580 and 582 are passed through the aligned openings of the first and second roller wheels 528 and 529 and the first and second glide bearing hold down washers 548 and 550), the tails are permanently deformed to secure the components of the chain element radial load bearing 506 in place relative to the male hub portion 539. As can be appreciated, the male hub portion 539 may be understood to define a roller rivet fastener for the chain element radial load bearing 506.

As discussed above, a keyed locking interface is defined between the female hub portion 536 and the male hub portion 539. More specifically, corresponding opposing locking shoulder surfaces of the male hub portion 539 and the female hub portion 536 engage one another and substantially prevent axial and rotational movement of the first and second roller wheels 528 and 529 relative to one another. The keyed locking interface defined between the female hub portion 536 and the male hub portion 539 defines, in part, the synchronous-motion assembly and the connection assembly because it rotationally constrains the first and second roller wheels 528 and 529 relative to each other. In that regard, the first and second roller wheels 528 and 529 rotate substantially in unison.

In previous designs using plastic wheels, slippage occurred between the wheels, causing a rotation angle offset of the wheel pair. Also, as noted above, previous designs caused the first roller wheel to be urged upwardly and inwardly as radial forces were applied to the first roller wheel, separating the first roller wheel from the second roller wheel. Separation of the roller wheels caused the lateral ends of the spring clips to bend at a greater angle than they had been designed to bend. The wheel slippage and vertical separation resulted in fatigue stress and cyclic loading on the spring clip, leading to crack propagation, especially at the sharp edges of mating surfaces. Crack propagation weakens the spring clip and threatens the integrity of the bearing chain assembly.

The chain element radial load bearing 506 of the present disclosure has addressed this issue by utilizing the synchronous-motion assembly, including the connection assembly, to rotationally constrain the first and second roller wheels 528 and 529 relative to each other. The first and second roller wheels 528 and 529 are forced to roll substantially synchronously and in axial alignment. Further, the wheel design of the chain element radial load bearing 506 substantially prevents vertical wheel separation. Rather, the outer surfaces of the first and second roller wheel portions 575 and 579 of the first and second roller wheels 528 and 529 substantially stay engaged with the radial surfaces of the drive path during rolling. Substantially synchronous rolling results in radial loads acting concurrently on both the first and second wheels 528 and 529, further resulting in a symmetric load on the cylindrical hub defined by the mated male hub portion 539 and female hub portion 536. A symmetric load prevents the bearing chain assembly 500 from twisting and reduces cyclic loading on the components of the chain element radial load bearing 506.

The synchronous-motion assembly is also configured to rotationally constrain the first and second glide bearings 524 and 526 relative to the first and second roller wheels 528 and 529. With reference to the interaction of the first glide bearing 524 and first roller wheel 528, the glide bearing body 533 of the first glide bearing 524 is configured to lockingly engage with the exterior glide bearing recess 534 of the first roller wheel 528, as discussed above. For instance, the glide bearing body 533 has a first annular portion 581 that can be positively locked in the exterior glide bearing recess 534 of the first roller wheel 528.

In another aspect, the glide bearing body 533 has a top geometry that helps facilitate rotational constraint of the first glide bearing 524 relative to the first roller wheel 528. In the depicted example, the top geometry of the glide bearing body 533 non-rotationally interfaces with the first glide bearing hold down washer 548 configured to receive a pressing force of the first tail 580 when deformed.

In the depicted example, the glide bearing body 533 includes a circumferential wall 564 that extends substantially transversely between the horizontal surface of the second transverse annular lip 587 and the exterior glide bearing surface 585. The circumferential wall 564 is configured to define a receptacle within the top of the first glide bearing 524 having a cross-sectional shape for non-rotationally receiving the first glide bearing hold down washer 548. In the example depicted, the circumferential wall 564 is segmented into multiple sections to define an overall non-circular cross-sectional wall shape. For instance, the substantially transverse circumferential wall 564 may include eight sections to create an octagonally-shaped receptable for non-rotationally receiving a correspondingly shaped first glide bearing hold down washer 548. Of course, other shapes are possible.

The first and second glide bearing hold down washers 548 and 550, when non-rotationally received within the first and second glide bearings 524 and 526, are generally configured to axially secure the first and second glide bearings 524 and 526 to the first and second roller wheels 528 and 529 through the pressing force of the first and second tails 580 and 582 of the male hub portion 539. The first and second glide bearing hold down washers 548 and 550 are identical, and therefore, only the first glide bearing hold down washer 548 will be described in detail.

The first glide bearing hold down washer 548 has a substantially planar body that is shaped to generally correspond to the overall combined shape of the second transverse annular lip 587 of the first glide bearing 524 and the substantially flat circular bottom portion 571 of the exterior glide bearing recess 534 when the first glide bearing 524 is mated against the first roller wheel 528. Moreover, a central opening of the first glide bearing hold down washer 548 is substantially aligned with and is generally the same overall circular size as the central opening in the first roller wheel 528 and the first cylindrical protruding end portion 592 of the male hub portion 539. In that regard, the first tail 580 of the male hub portion 539 may impose a pressing force against the first glide bearing hold down washer 548. In effect, the first glide bearing hold down washer 548 imposes a pressing force against both the second transverse annular lip 587 of the first glide bearing 524 and the substantially flat circular bottom portion 571 of the first and second roller wheels 528.

An opposing pressing force is imposed by the second tail 582 of the male hub portion 539 against the second glide bearing hold down washer 550. In effect, the second glide bearing hold down washer 550 imposes a pressing force against both the second transverse annular lip 587 of the second glide bearing 526 and the substantially flat circular bottom portion 571 of the second roller wheel 529. The opposing pressing forces imposed by the first and second tails 580 and 582 of the male hub portion 539 lock the components of the chain element radial load bearing 506 in place.

Detailed exemplary aspects of the chain connection radial load bearing 504 of the bearing chain assembly 500 will now be described with reference to FIGS. 20-22, 23B and 24B. The chain connection radial load bearing 504 is substantially similar to the chain element radial load bearing 506 in that it generally includes a roller assembly configured to facilitate rolling of the bearing chain assembly 500 along radial surfaces of the drive path, a glide bearing assembly configured to facilitate sliding movement of the bearing chain assembly 500 along curved upper and lower surfaces of the return path, a connection assembly configured to secure the roller and bearing components relative to one another, and a synchronous-motion assembly configured to substantially maintain alignment and synchronous movement of the roller components during operation.

However, the chain connection radial load bearing 504 is also configured for connecting opposite ends of the bearing chain assembly 500 to assemble the bearing chain assembly 500 as a continuous endless loop. In that regard, the chain connection radial load bearing 504 differs from the chain element radial load bearing 506 in that the connection assembly and synchronous-motion assembly also facilitate disassembly of the roller and bearing components. With the chain connection radial load bearing 504 disassembled, a first end of the bearing chain assembly 500 can be connected to a second end of the bearing chain assembly 500 by securing the relevant portion of the linkage assembly between end horizontal and vertical load bearings. As discussed above, the linkage assembly is configured to hold neighboring horizontal and vertical load bearing assemblies 504/506 and 108 in a spaced relationship relative to each other.

The chain element radial load bearing 506 is identical to the chain connection radial load bearing 504 except for the differences in the connection assembly and synchronous-motion assembly, which are configured to support disassembly of the roller and bearing components. Thus, only aspects of the 504 that differ from the chain element radial load bearing 506 will be hereinafter described in detail. Moreover, identical parts use identical reference numbers for ease of reference.

Like the chain connection radial load bearing 504, the chain element radial load bearing 506 includes the first roller wheel 528, the first and second glide bearings 524 and 526, and the first and second glide bearing hold down washers 548 and 550. However, the chain connection radial load bearing 504 includes a second roller wheel 531 having a modified male hub portion 540 to facilitate disassembly of the chain connection radial load bearing 404.

The second roller wheel 531 is identical to the second roller wheel 529 of the chain element radial load bearing 506 except that the modified male hub portion 540 is configured to a impose a selective pressing force on the first glide bearing hold down washer 448 (and therefore the first glide bearing 424 and the first roller wheel 428). The modified male hub portion 540 is configured to a impose a selective pressing force on the first glide bearing hold down washer 448 with a removable, rather than a permanent, fastener to facilitate disassembly of the chain connection radial load bearing 504.

In the depicted example, a threaded, axial receptacle 584 extends from an outer surface of the second cylindrical hub portion 543 into the male hub portion 539. The threaded, axial receptacle 584 is configured to threadably receive a fastener 586, such as a hex screw, a bolt, etc., therein. A head of the fastener 586 is configured to impose a pressing force on the first glide bearing hold down washer 548. The opposing pressing forces imposed by the second tail 582 of the male hub portion 539 and the fastener 586 lock the components of the chain connection radial load bearing 504 in place.

At least one washer may be disposed between the head of the fastener 586 and the first glide bearing hold down washer 548 to help distribute the pressing load of the fastener 586 and to help retain threaded engagement of the fastener 586 with the axial receptacle 584. In the depicted example, an internal tooth lock washer 588 is located above the first glide bearing hold down washer 548, and a flat washer 589 is disposed between the teeth of the internal tooth lock washer 588 and the bottom surface of the fastener head. The pressing force of the fastener 586 passes through the flat washer 589, the internal tooth lock washer 588, and down into the first glide bearing 524 and the first roller wheel 528.

The internal tooth lock washer 588 may have an overall shape configured to be non-rotationally received within the first glide bearing hold down washer 548 and/or non-rotationally received within the first glide bearing 524. In that regard, the internal tooth lock washer 588 has a substantially planar body that is shaped to generally correspond to the overall combined shape of the second transverse annular lip 587 of the first glide bearing 524 and the substantially flat circular bottom portion 571 of the exterior glide bearing recess 534 when the first glide bearing 524 is mated against the first roller wheel 528. With the internal tooth lock washer 588 locked into position within the first glide bearing hold down washer 548 and first glide bearing 524, manner, the internal tooth lock washer 588, flat washer 589, and fastener 586 rotate synchronously with the first glide bearing 524 and the first roller wheel 528. Accordingly, the interface between the internal tooth lock washer 588 and the first glide bearing hold down washer 548 may be understood to define a portion of the synchronous-motion assembly.

As can be appreciated, the modified male hub portion 540, fastener 586, internal tooth lock washer 588, and flat washer 589 collectively provide connection assembly and synchronous-motion assembly capabilities a while facilitating disassembly of the chain connection radial load bearing 504. When a chain connection radial load bearing 504 at a first end of the bearing chain assembly 500 is disassembled, the chain connection radial load bearing 504 can be connected to a vertical load bearing 108 at the second end of the bearing chain assembly 500 via the linkage.

It should be appreciated that both the chain connection radial load bearing 504 and the chain element radial load bearing 506 may instead be configured to include only a single glide bearing like the radial load bearing 204 described above with reference to FIGS. 12 and 13. For instance, the chain connection radial load bearing 504 and the chain element radial load bearing 506 may include only one glide bearing, e.g., the second glide bearing 526 may be excluded. In such an example, the second glide bearing hold down washer 550 may be adapted to mate directly with the second roller wheel 529 and the second cylindrical protruding end portion 596 of the male hub portion 539.

Various examples of the disclosure are discussed in detail above. While specific implementations are discussed, it should be understood that this description is for illustration purposes only. A person skilled in the relevant art will recognize that other components and configurations may be used without parting from the spirit and scope of the disclosure. Thus, the description and drawings are illustrative and are not to be construed as limiting.

Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative example examples mutually exclusive of other example examples. Moreover, various features are described which may be exhibited by some example examples and not by others. Any feature of one example can be integrated with or used with any other feature of any other example.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

Language such as “top”, “bottom”, “upper”, “lower”, “vertical”, “horizontal”, “lateral”, etc., in the present disclosure is meant to provide orientation for the reader with reference to the drawings and is not intended to be the required orientation of the components or to impart orientation limitations into the claims.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms.

Unless otherwise defined, technical and scientific terms used herein have the meaning as commonly understood by one of ordinary skill in the art to which this disclosure pertains. In the case of conflict, the present document, including definitions will control.

Headings, titles, or subtitles of sections provided in this patent application and the title of this patent application are for convenience only and are not to be taken as limiting the disclosure in any way. Note that headings, titles, or subtitles may be used in the examples for convenience of a reader, which in no way should limit the scope of the disclosure.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, it may not be included or may be combined with other features.

While illustrative embodiments have been illustrated and described, it will be appreciated that various changes can be made therein without departing from the spirit and scope of the invention.

The embodiments of the invention in which an exclusive property or privilege is claimed are defined as follows:

1. A bearing chain assembly for use in a spiral conveyor belt drive system, comprising:
a plurality of vertical load bearings configured to roll along horizontal support structure of the drive system while supporting vertical loads of a spiral conveyor belt, each of the plurality of vertical load bearings having a first rotation axis; and
a plurality of radial load bearings alternately coupled with the plurality of vertical load bearings, each radial load bearing comprising:
a roller assembly configured to facilitate rolling of the bearing chain assembly along vertical support structure of the drive system while supporting radial loads of at least one of the spiral conveyor belt and the drive system, the roller assembly including a first roller wheel having a first rolling surface and positioned opposite and substantially mirrored in configuration relative to a second roller wheel having a second rolling surface, the first and second roller wheels having a rotation axis substantially perpendicular to the first rotation axis, the first and second roller wheels made of a first material;
a glide bearing assembly configured to facilitate sliding movement of the bearing chain assembly along curved support structure of the drive system, the glide bearing assembly comprising a first glide bearing secured to the first roller wheel, the first glide bearing made of a second material having a lower frictional resistance than the first material; and
a connection assembly configured to couple the first wheel to the second wheel.

2. The bearing chain assembly of claim 1, wherein the first and second wheels of the bearing chain assembly are made of steel, and wherein the first glide bearing is made of plastic.

3. The bearing chain assembly of claim 1, further comprising a synchronous-motion assembly configured to substantially maintain axial alignment and synchronous movement of the first and second roller wheels during rolling movement.

4. The bearing chain assembly of claim 3, wherein the synchronous-motion assembly is configured to maintain substantially continuous engagement of the first and second rolling surfaces of the first and second roller wheels with the vertical support structure of the drive system when the bearing chain assembly is rolling along vertical support structure of the drive system.

5. The bearing chain assembly of claim 4, wherein at least one of the synchronous-motion assembly and the connection assembly comprises:
a through-shaft having a first cylindrical protruding end portion opposite a second cylindrical protruding end portion, the first cylindrical protruding end portion receivable within correspondingly shaped openings in the first glide bearing and first roller wheel, the second cylindrical protruding end portion receivable within a correspondingly shaped opening in the second roller wheel;
a first biasing device receivable within a recessed portion of the first glide bearing, the first biasing device configured to interface with the first cylindrical protruding end portion to urge the first glide bearing into engagement with the first roller wheel and toward the second roller wheel; and
a second biasing device configured to interface with the second cylindrical protruding end portion to urge the second roller wheel toward the first roller wheel.

6. The bearing chain assembly of claim 5, wherein a cross-sectional shape and size of the first cylindrical protruding end portion and the correspondingly shaped opening in the first roller wheel is configured to substantially prevent rotation of the first roller wheel with respect to the through-shaft.

7. The bearing chain assembly of claim 3, wherein at least one of the synchronous-motion assembly and the connection assembly comprises:
a female hub portion extending axially from the first roller wheel and having a first mating interface;
a male hub portion extending axially from second roller wheel and having a second mating interface that is configured to lockingly mate against the first mating interface;
a first protruding end defined on a first end of the male hub portion configured to lockingly interface with the first roller wheel and the first glide bearing; and
a second protruding end defined on a second end of the male hub portion configured to lockingly interface with the second roller wheel.

8. The bearing chain assembly of claim 7, wherein a first rivet is defined on the first protruding end of the male hub portion to secure the first glide bearing to the first roller wheel.

9. The bearing chain assembly of claim 8, further comprising a first glide bearing hold down washer lockingly receivable within a recesses portion of the first glide bearing, the first protruding end defined on the first end of the male hub portion configured to lockingly interface with the first glide bearing hold down washer.

10. The bearing chain assembly of claim 8, wherein a cross-sectional shape and size of the first protruding end of the male hub portion and a correspondingly shaped opening in the first roller wheel is configured to substantially prevent rotation of the first roller wheel with respect to the male hub portion.

11. The bearing chain assembly of claim 7, further comprising a threaded axial receptacle defined within the first protruding end of the male hub portion, the threaded axial receptacle configured to removably receive a threaded fastener to secure the first glide bearing to the first roller wheel.

12. The bearing chain assembly of claim 11, further comprising at least one washer lockingly receivable within a recessed portion of the first glide bearing, the threaded fastener configured to lockingly interface with the at least one washer.

13. The bearing chain assembly of claim 7,
wherein a first radial load bearing of the plurality of radial load bearings comprises:
a rivet defined on the first protruding end of the male hub portion to secure the first glide bearing to the first roller wheel;
wherein a second radial load bearing of the plurality of radial load bearings comprises:
a threaded axial receptacle defined within the first protruding end of the male hub portion, the threaded axial receptacle configured to removably receive a threaded fastener to secure the first glide bearing to the first roller wheel.

14. The bearing chain assembly of claim 7, wherein the female hub portion and the first roller wheel are cast from the first material, and wherein the male hub portion and the second roller wheel are cast from the first material.

15. The bearing chain assembly of claim 1, wherein the first roller wheel of the bearing chain assembly is configured to partially house the first glide bearing in a recessed substantially center portion of the first wheel.

16. The bearing chain assembly of claim 15, wherein a cross-sectional shape and size of the recessed substantially center portion in the first roller wheel and a correspondingly shaped protruding portion of the first glide bearing are configured to substantially prevent rotation of the first glide bearing with respect to the first roller wheel.

17. The bearing chain assembly of claim 1, wherein the first roller wheel includes a plurality of tabs defined on an exterior surface and extending generally transverse to the first rolling surface and the first glide bearing includes a corresponding plurality of slots defined on an interior surface that are configured to mate with the plurality of tabs on the first roller wheel.

18. A radial load bearing for use in a bearing chain assembly having a plurality of radial load bearings alternately coupled with a plurality of vertical load bearings configured to roll along horizontal support structure of a drive system while supporting vertical loads of a spiral conveyor belt, each of the plurality of vertical load bearings having a first rotation axis, each radial load bearing comprising:
a roller assembly configured to facilitate rolling of the bearing chain assembly along vertical support structure of the drive system while supporting radial loads of at least one of the spiral conveyor belt and the drive system, the roller assembly including a first roller wheel having a first rolling surface positioned opposite and substantially mirrored in configuration relative to a second roller wheel having a second rolling surface, the first and second roller wheels having a rotation axis substantially perpendicular to the first rotation axis, the first and second roller wheels made of a first material;
a glide bearing assembly configured to facilitate sliding movement of the bearing chain assembly along curved support structure of the drive system, the glide bearing assembly comprising a first glide bearing secured to the first roller wheel, the first glide bearing made of a second material having a lower frictional resistance than the first material; and
a connection assembly configured to couple the first wheel to the second wheel.

19. The radial load bearing of claim 18, further comprising:
a female hub portion extending axially from the first roller wheel and having a first mating interface;
a male hub portion extending axially from second roller wheel and having a second mating interface that is configured to lockingly mate against the first mating interface;
a first protruding end defined on a first end of the male hub portion configured to lockingly interface with the first roller wheel and the first glide bearing; and
a second protruding end defined on a second end of the male hub portion configured to lockingly interface with the second roller wheel.

20. A spiral conveyor belt assembly for a thermal processing system, comprising:
a perforated conveyor belt;
a supporting structure configured to hold the conveyor belt in a series of spiral tiers;
a drive system configured to drive a drive chain for moving the conveyor belt;
a bearing chain assembly configured for supporting movement of the drive chain and conveyor belt, comprising:
a plurality of vertical load bearings configured to roll along horizontal support structure of the drive system while supporting vertical loads of a spiral conveyor belt, each of the plurality of vertical load bearings having a first rotation axis; and
a plurality of radial load bearings alternately coupled with the plurality of vertical load bearings, each radial load bearing comprising:
a roller assembly configured to facilitate rolling of the bearing chain assembly along vertical support structure of the drive system while supporting radial loads of at least one of the spiral conveyor belt and the drive system, the roller assembly including a first roller wheel having a first rolling surface and positioned opposite and substantially mirrored in configuration relative to a second roller wheel having a second rolling surface, the first and second roller wheels having a rotation axis substantially perpendicular to the first rotation axis, the first and second roller wheels made of a first material;
a glide bearing assembly configured to facilitate sliding movement of the bearing chain assembly along curved support structure of the drive system, the glide bearing assembly comprising a first glide bearing secured to the first roller wheel, the first glide bearing made of a second material having a lower frictional resistance than the first material; and
a connection assembly configured to couple the first wheel to the second wheel.
